(19) United States
(12) Patent Application Publication
(10) Pub. No.: US 2012/0312379 A1
(43) Pub. Date: Dec. 13, 2012

(54) HEATING AND COOLING SYSTEMS AND METHODS

(75) Inventors: Thomas P. Gielda, Saint Joseph, MO (US); Jayden D. Harman, San Rafael, CA (US); Kasra Farsad, San Jose, CA (US)

(73) Assignee: Caitin, Inc.

(21) Appl. No.: 13/349,429

(22) Filed: Jan. 12, 2012

Related U.S. Application Data
(60) Provisional application No. 61/433,165, filed on Jan. 14, 2011.
(60) Provisional application No. 61/443,705, filed on Feb. 16, 2011.

(51) Int. Cl. F16L 53/00

(52) U.S. Cl. 137/1; 137/334

(57) ABSTRACT

A fluid flow system comprises a first pump and an ejector downstream of the pump. The first pump facilitates the flow of a driver fluid through the ejector. In the ejector, the driver fluid mixes with a suction fluid. The ejector is operatively coupled to a fluid reservoir, which in some cases is associated with a cycle having a second pump and an evaporator. The fluid reservoir includes the suction fluid. A heat exchanger downstream of the ejector removes heat from the driver fluid, and from the heat exchanger the driver fluid is directed to the first pump. The fluid flow system can include a fluid separator downstream of the ejector for separating the driver fluid from the suction fluid.

### CROSS-REFERENCE

This application claims the benefit of U.S. Provisional Application No. 61/433,165 filed Jan. 14, 2011, and U.S. Provisional Application No. 61/443,705, filed Feb. 16, 2011, which applications are entirely incorporated herein by reference.

### BACKGROUND OF THE INVENTION

A vapor compression system typically includes a compressor, a condenser, and an evaporator, and in some cases an expansion device. In a vapor compression system, a refrigerant gas is compressed, whereby the temperature of the gas is increased beyond that of the ambient temperature. The compressed gas then flows through a condenser and turned into a liquid. The condensed and liquefied gas then flows through an expansion device, which drops the pressure and the corresponding temperature of the fluid. The refrigerant is then boiled in an evaporator.

FIG. 1 illustrates a vapor compression system 100, as may be found in some current vapor compression systems, such as those used in a home or automotive vapor compression system. In the system 100, a compressor 110 compresses a gas to a pressure of about 238 pounds per square inch (PSI) and a temperature of about 190° F. A condenser 120 then liquefies the heated and compressed gas to a pressure of about 220 PSI and a temperature of about 117° F. The gas that was liquefied by the condenser 120 then flows through an expansion valve 130, at which point the pressure of the gas drops to about 20 PSI. A corresponding drop in temperature accompanies the drop in pressure, which is reflected as a temperature drop to about 34° F. The refrigerant that results from dropping the pressure and temperature at the expansion value 130 boils at evaporator 140, which generates a low temperature vapor as having a temperature of about 39° F. and a pressure of about 20 PSI.

The system 100 operates at an efficiency (e.g., coefficient of performance) that is below its potential. To compress gas in the system 100 typically requires about 1.75-2.5 kilowatts for every 5 kilowatts of cooling power. This exchange rate is less than optimal and may directly correlate with the rise in pressure times the volumetric flow rate. Degraded performance is similarly and ultimately related to performance (or lack thereof) by the compressor 110.

### SUMMARY OF THE INVENTION

Recognized herein is a need for improved heat exchange systems, and in particular cooling and heating systems that better recognize system potential and overcome technical barriers due to system performance.

Provided herein are cooling and heating systems that that are configured to provide heating and/or cooling at improved coefficient of performance (COP) in relation to other systems currently available. In some instances, cooling and/or heating system provided herein can operate without the use of a compressor. During operation, such systems can be quiet in relation to other systems currently available, thereby aiding in minimizing noise pollution in urban and industrial settings. The improved performance of systems provided herein aids in minimizing environmental pollution and helping offset or mitigate the effects of global warming.

An aspect of the invention provides a fluid flow system comprising (a) a first cycle for facilitating circulatory fluid flow of a working fluid, the first cycle comprising: (i) a first pump for pressurizing the working fluid to an elevated pressure; (ii) an evaporator downstream of the first pump; and (iii) a reservoir downstream of the evaporator and in fluid communication with the first pump. The fluid flow system further comprises (b) a second cycle for facilitating circulatory fluid flow of a carrier fluid, the second cycle comprising: (i) a second pump; (ii) an ejector downstream of the second pump, the ejector for entraining a suction fluid from the reservoir of the first cycle with the carrier fluid upon the flow of the carrier fluid through the ejector; (iii) a fluid separator downstream of the ejector; and (iv) a heat exchanger downstream of the fluid separator, the heat exchanger in fluid communication with the second pump. The fluid separator has a first fluid stream leading to the heat exchanger and a second fluid stream leading to the reservoir of the first cycle. In an embodiment, the first fluid stream directs the carrier fluid to the second pump and the second fluid stream directs the suction fluid to the reservoir. In another embodiment, the first fluid stream includes the carrier fluid. In another embodiment, the second fluid stream includes the suction fluid. In another embodiment, the reservoir is in fluid communication with the ejector. In another embodiment, the heat exchanger is in thermal communication with a secondary fluid for a heating system. In another embodiment, the evaporator is in thermal communication with a secondary fluid for a cooling system. In another embodiment, the evaporator includes a converging-diverging nozzle. In another embodiment, the fluid flow system has a COP of at least about 2. In another embodiment, the fluid flow system has a COP of at least about 4.

Another aspect of the invention provides a fluid flow system, comprising a pump for increasing the pressure of a carrier fluid; an ejector downstream of the pump, wherein the carrier fluid is mixed with a suction fluid in the ejector to form a mixed fluid; a heat exchanger downstream of the ejector, the heat exchanger for removing heat from the mixed fluid; an evaporator downstream of the heat exchanger, the evaporator for facilitating the vaporization of the suction fluid; and a fluid separator downstream of the evaporator, the fluid separator having a first stream leading to a suction port of the ejector, the first stream having the suction fluid, and a second stream leading to the pump, the second stream having the carrier fluid. In an embodiment, the fluid separator is a reservoir. In another embodiment, the system further comprises a second heat exchanger downstream of the fluid separator and upstream of the pump. In another embodiment, the fluid flow system further comprises a de-gasser downstream of the fluid separator and upstream of the pump. In another embodiment, the fluid flow system has a COP of at least about 2. In another embodiment, the fluid flow system has a COP of at least about 4. In another embodiment, the evaporator is in thermal communication with a secondary fluid for a cooling system. In another embodiment, the evaporator includes a converging-diverging nozzle.

Another aspect of the invention provides a fluid flow system comprising a first pump for directing a carrier fluid along a fluid flow path; an ejector along the fluid flow path, the ejector for directing the carrier fluid and for mixing the carrier fluid with a suction fluid supplied with the aid of suction generated by the ejector upon the flow of the carrier fluid, wherein the ejector has a suction reservoir operatively coupled to a fluid reservoir of a cycle having a second pump and an evaporator, the fluid reservoir having the suction fluid; and a heat exchanger downstream of the ejector, the heat exchanger for removing heat from the carrier fluid and for directing the carrier fluid to the first pump. In an embodiment, the fluid flow system further comprises one or more additional ejectors along the fluid flow path. In another embodiment, the fluid flow system further comprises a fluid separator between the ejector and the heat exchanger, the fluid separator having a first stream in fluid communication with the heat exchanger, the first stream providing the carrier fluid to the heat exchanger, and a second stream in fluid communication with the fluid reservoir, the second stream providing the suction fluid to the fluid reservoir. In another embodiment, the evaporator is a converging-diverging nozzle.

Another aspect of the invention provides a fluid flow system comprising a fluid flow path having a high pressure region and a low pressure region, the fluid flow path transporting a flow of liquid at a velocity that is greater than or equal to the speed of sound when the liquid is transported from the high pressure region of the fluid flow path to the low pressure region of the fluid flow path, the fluid flow system emitting sound of at most about 70 decibels. In an embodiment, the fluid flow system emits sound of at most about 30 decibels. In another embodiment, the fluid flow system further comprises a pump for facilitating the flow of liquid, wherein the pump is disposed at the high pressure region of the fluid flow path. In another embodiment, the fluid flow system further comprises an evaporator downstream of the pump, the evaporator facilitating a decrease in pressure of the fluid. In another embodiment, the fluid flow system further comprises an ejector in fluid communication with the fluid flow path, wherein the ejector provides a decreased pressure downstream of the evaporator and upstream of the pump. In another embodiment, the fluid flow system further comprises an ejector in fluid communication with the fluid flow path. In another embodiment, the fluid flow system further comprises an enclosure. In some cases, the fluid flow system is housed within the enclosure. The enclosure can have a cross-sectional area less than about The enclosure can have a cross-sectional area less than about 100 m², 80 m², 60 m², 40 m², 20 m², 15 m², 10 m², 5 m², 2 m², 1 m², 0.5 m², or 0.1 m². In another embodiment, the fluid flow system has a coefficient of performance of at least about 2, 4, 6, 8, or 10.

Another aspect of the invention provides a fluid flow system, comprising a pump in fluid communication with a fluid flow path. The pump circulates a working liquid through the fluid flow path at a critical flow rate. The cooling system emits sound of at most about 70 decibels and has a COP of at least about 2. In an embodiment, the fluid flow system has a COP of at least about 4. In another embodiment, the fluid flow system emits sound of at most about 30 decibels.

Another aspect of the invention provides a fluid flow system comprising (a) a pump for directing a motive fluid along a fluid flow path; (b) an ejector along the fluid flow path, the ejector for mixing the motive fluid with a suction fluid supplied with the aid of suction generated by the ejector upon the flow of the motive fluid through the ejector; and (c) a fluid separator downstream of the ejector. In an embodiment, the fluid separator comprises (i) a first stream in fluid communication with a suction port of the ejector, the first stream directing the suction fluid to the suction port; and (ii) a second stream directing the motive fluid from the fluid separator to the pump. In an embodiment, the fluid flow system further comprises a fluid reservoir in fluid communication with the fluid separator and the suction port, wherein the first stream directs the suction fluid to the fluid reservoir. In another embodiment, the fluid reservoir is operatively coupled to a cycle having a second pump and an evaporator, the fluid reservoir having a working fluid of the first cycle. In another embodiment, the fluid flow system further comprises a heat exchanger in thermal communication with the suction fluid in the first stream, the heat exchanger for adding heat to the suction fluid. In another embodiment, the ejector has a suction reservoir in fluid communication with the suction port. In another embodiment, the fluid flow system further comprises (d) a heat exchanger downstream of the fluid separator, the heat exchanger for transferring heat to or from the motive fluid and for directing the motive fluid to the pump. In another embodiment, the heat exchanger removes heat from the motive fluid.

Another aspect of the invention provides a cooling or heating system having a fluid flow system as described above, alone or in combination.

Another aspect of the invention provides a heating and/or cooling method, comprising providing a fluid flow system as described above, alone or in combination, and heating or cooling a fluid with the aid of the fluid flow system.

Another aspect of the invention provides a method for directing a working fluid through a fluid flow path, comprising (a) directing the working fluid from a fluid reservoir to a pump, the fluid reservoir having a suction fluid and the working fluid; (b) increasing the pressure of the working fluid using the pump, wherein the increase in pressure of the working fluid is isenthalpic; (c) directing the working fluid to an evaporator. In the evaporator: a. the pressure of the working fluid is isenthalpically decreased; b. the enthalpy of the working fluid is increased at constant enthalpy; and c. the pressure of the working fluid is isenthalpically increased. The working fluid is then directed to the fluid reservoir. Suction is supplied to the fluid reservoir with the aid of a fluid flow system having an ejector. The ejector draws the suction fluid from the fluid reservoir into the ejector upon the flow of a carrier fluid through the ejector. In an embodiment, the suction fluid separable from the working fluid. In another embodiment, the evaporator includes a converging-diverging nozzle. In another embodiment, the working fluid is directed through the evaporator at a velocity that is greater than or equal to the speed of sound. In another embodiment, the ejector has a suction reservoir that is operatively coupled to the fluid reservoir. In another embodiment, the method further comprises (a) directing the carrier fluid, with the aid of a second pump of the fluid flow system, to the ejector; (b) mixing the carrier fluid with the suction fluid from the fluid reservoir to form a mixed fluid; (c) directing the mixed fluid to a fluid separator; (d) at least partially separating the suction fluid from the carrier fluid; and (e) directing the carrier fluid to the pump and the suction fluid to the fluid reservoir. In another embodiment, heat is removed from the carrier fluid with the aid of a heat exchanger between the fluid separator and the second pump. In another embodiment, the removed heat is supplied to a heating system. In another embodiment, in the evaporator, heat added to the working fluid is supplied by a secondary fluid in thermal communication with the evaporator.

Another aspect of the invention provides a low noise cooling method, comprising flowing a liquid through a fluid flow path with the aid of a pump. The liquid flows at a critical flow rate at a low pressure region of the fluid flow path, and the sound emitted by the pump and the fluid flow path is at most about 60 decibels. In an embodiment, the sound emitted by the pump and the fluid flow path is at most about 30 decibels.

Another aspect of the invention provides a controller for a fluid flow system, comprising a memory location having machine executable code implementing a method as in any of the claims above, alone or in combination. The controller further comprises a processor for implementing the machine executable code.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” and “FIGs.” herein) of which:

FIG. 1 schematically illustrates a vapor compression system, as may be found in some current systems;

FIG. 2 schematically illustrates a fluid flow system, in accordance with an embodiment of the invention;

FIG. 3 is a schematic cross-sectional side-view of a converging-diverging nozzle, in accordance with an embodiment of the invention;

FIGS. 4A and 4B are schematic cross-sectional side and perspective side views, respectively, of an ejector, in accordance with an embodiment of the invention;

FIG. 5 schematically illustrates a fluid flow system, in accordance with an embodiment of the invention;

FIG. 6 schematically illustrates a device that can be used to implement the fluid flow system of FIG. 5, in accordance with an embodiment of the invention;

FIG. 7 schematically illustrates a circulatory flow system, in accordance with an embodiment of the invention;

FIG. 8 illustrates a pressure-enthalpy plot of a first cycle of FIG. 2, in accordance with an embodiment of the invention;

FIG. 9 schematically illustrates a serial ejector system, in accordance with an embodiment of the invention;

FIG. 10 schematically illustrates a multi-phase cooling system, in accordance with an embodiment of the invention; and

FIG. 11 shows a plot having reservoir temperature with time for two exemplary use cases.

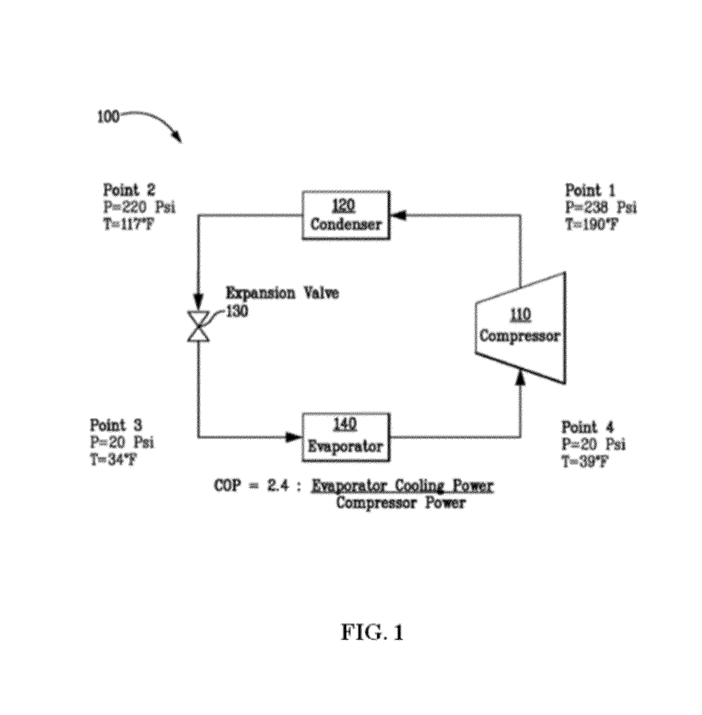

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed in practicing the invention.

The term “fluid,” as used herein, refers to a substance capable of flowing through a fluid flow path and phase change. A fluid can include a liquid, gas, plasma, or semi-solid, such as a gel-like substance, or a mixture of fluids, such as a gas-liquid mixture. A fluid can include a refrigerant for cooling and/or heating purposes. In some embodiments, a fluid can be selected from an organic (e.g., carbon-containing species) and/or inorganic substances, such as a substance including one or more —OH groups, ═O groups, carbon-to-carbon double bonds, and/or carbon-to-carbon triple bonds. In an example, a fluid can be selected from water, alcohols (e.g., methanol, ethanol), aldehydes, ketones, carboxylic acids, and combinations thereof, such as a water-alcohol mixture (e.g., water-methanol mixture). In another example, a fluid can be selected from a flurocarbon, such as CHCl₃. In another example, a fluid can be selected from a haloalkane refrigerant, such as tetrafluoroethane (CH₂FCF₃), or generally R-134 gases.

The term “secondary fluid,” as used herein, refers to a fluid for use in removing heat from, or adding heat to, another fluid. A secondary fluid can be a liquid, gas, gas-solid or gas-liquid mixture. In some cases, a secondary fluid is air.

The term “cycle,” as used herein, refers to a system having one or more components (or unit operations, also “units” herein) for facilitating fluid flow and/or fluid phase change, such as pumps, nozzles, ejectors, fluid separators, heat exchangers and reservoirs. A cycle can be a circulatory flow system. In the context of such circulatory flow systems, the terms “downstream” and “upstream” are used to indicate the location of one component in relation to another component along a fluid flow path that brings the components in fluid communication with one another. Components can be interconnected with the aid of fluid flow paths (or fluid streams, also “streams” herein), which can include channels, fluid passages or conduits for aiding in fluid flow from one unit to another.

Provided herein are fluid flow systems for various applications. Fluid flow systems can be circulatory systems using various unit operations to effect heating and/or cooling. A system in some cases includes a supersonic cooling cycle and an absorption loop. Systems provided herein can be configured for use in cooling systems (e.g., air conditioning system), heating systems or both heating and cooling systems, depending on the flow of heat to or from a target location and/or a secondary fluid. A secondary fluid can be used for heating or cooling purposes.

Systems and methods provided herein can provide improved performance over current cooling and heating systems and methods. Systems provided herein are based at least in part on the unexpected realization that the performance of a thermodynamic cooling system implemented by a first cycle can be improved with the aid of a second cycle having an ejector to lower a backpressure of the first cycle.

### Cooling and Heating Systems

An aspect of the invention provides a cooling and/or heating system comprising a first cycle and a second cycle. The second cycle is operatively coupled to the first cycle, such as through a fluid reservoir. During operation, the second cycle lowers a backpressure (i.e., the pressure upstream of a pump) of the first cycle, thereby providing for improved thermodynamic performance of the first cycle.

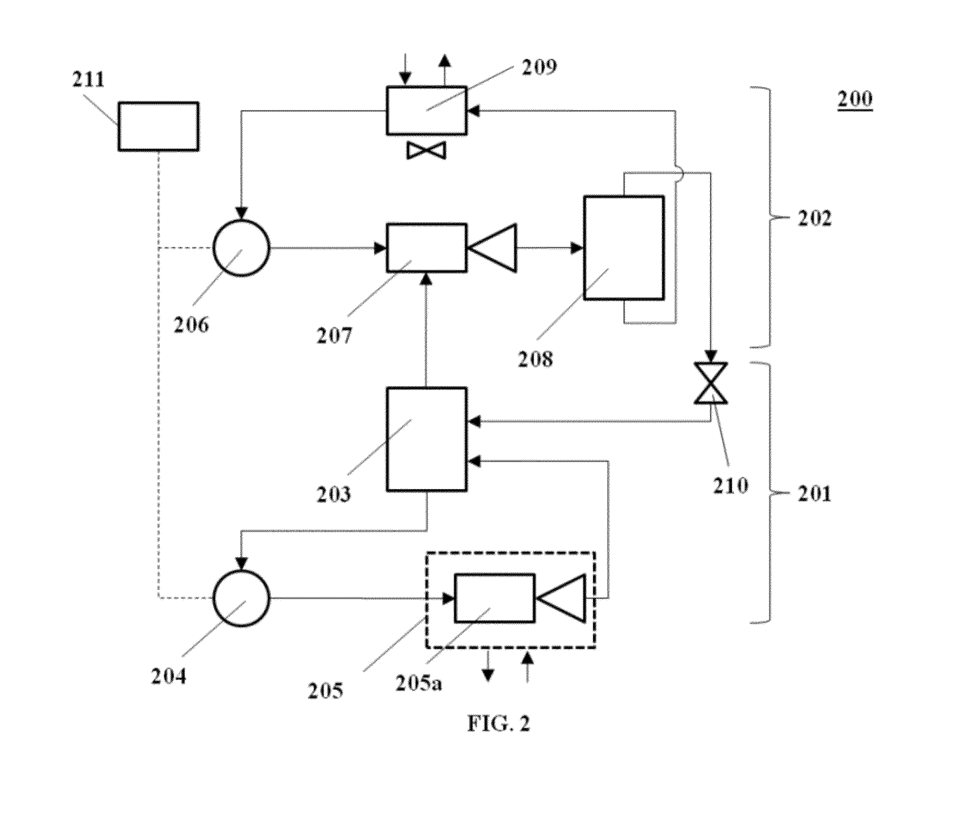

FIG. 2 schematically illustrates a fluid flow system 200, in accordance with an embodiment of the invention. The system 200 can be used in heating and/or cooling applications. The system 200 includes a first cycle 201 and second cycle 202 operatively coupled to the first cycle 201 through a reservoir 203. Each of the first cycle 201 and second cycle 202 includes a plurality of unit operations (“units”) for facilitating the flow of a fluid through a fluid flow path.

In some embodiments, the first cycle 201 and second cycle 202 can each be used for cooling and/or heating purposes. In an example, the second cycle 202 from the system 200 is precluded, and the first cycle 201 is used as part of a cooling system. In another example, the first cycle 201 from the system 200 is precluded, and the second cycle 202 is used as part of a cooling system.

While the system 200 includes one reservoir in the first cycle 201 that is coupled to the second cycle 202, the system 200 can include more than one reservoir, such as at least 2, 3, 4, 5, 6, 7, 8, 9, 10, or more reservoirs coupling the first cycle 201 to the second cycle 202.

The first cycle 201 includes a pump 204, an evaporator 205 and the reservoir 203. The evaporator 205 in some cases includes a nozzle 205a, such as a converging-diverging nozzle. In some embodiments, the nozzle 205a is configured to induce cavitation in a fluid (also “working fluid” herein) directed through the first cycle 201. The evaporator 205 can be in thermal communication with a heat exchanger, which can be used to cool a secondary fluid (as indicated by the arrows into and out of the evaporator 205). The evaporator 205 in some cases is a heat exchanger for facilitating the flow of heat to a working fluid directed through the evaporator 205. The secondary fluid can be water or other suitable refrigerant, such as an alcohol or hydrocarbon. The evaporator 205 can, in some cases, bring the secondary fluid in thermal communication with the working fluid of the first cycle 201. In some cases, the nozzle 205 can be an ejector, as described herein.

In some embodiments, the evaporator 205 can include one or more nozzles 205a. In an example, the evaporator 205 includes a single nozzle 205a. In another example, the evaporator 205 includes at least 2, 3, 4, 5, 6, 7, 8, 9, 10, 20, 30, 40, 50, 100, 500, 1000, or more nozzles 205a, such as in a parallel configuration—i.e., the nozzles 205a are directly coupled to an inlet and an outlet of the evaporator 205.

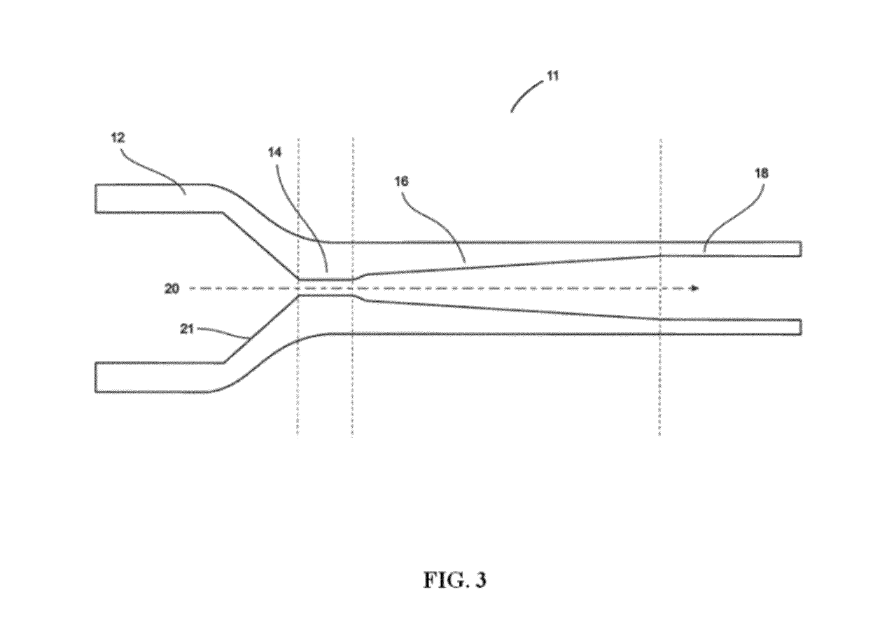

The nozzle 205a of FIG. 2 can have various sizes and configurations. In some embodiments, the nozzle 205a can be a convergent-divergent nozzle. FIG. 3 is a schematic cross-sectional side-view of a nozzle 11, in accordance with an embodiment of the invention. The nozzle 11 can be the nozzle 205a of the first cycle 201. The nozzle 11 can be configured to transfer heat to or from a working fluid flowing from the inlet portion 12, through the throat portion 14 and to the outlet portion 18. The nozzle 11 of FIG. 3 can be used in a commercial or residential air-conditioning system. The converging-diverging nozzle 11 of FIG. 3 includes an inlet portion 12, a throat portion 14, an expansion portion 16, an outlet portion 18, and a fluid pathway 20.

A surface of the throat portion 14 can be at least partially covered with a material to induce cavitation of the working fluid traversing the throat portion 14 from the inlet portion 12 to the outlet portion 18. Examples of materials that can be used to induce cavitation include nucleation materials, such as metals (e.g., Au, Ag, Pt, Cu, Ni, Fe), metal alloys, semiconductors, and/or silicides. Nucleation materials can include nucleation particles, such as microparticles or nanoparticles. In an example, the throat portion 14 includes metal-containing nanoparticles.

In some cases, the working fluid enters the inlet portion 12 as a liquid. The inlet portion 12 receives the working fluid from a pumped supply under pressure, such as the pump 204 of FIG. 2, at a pressure in the range of about 500 kPa to 2000 kPa. Pressures outside this range may be used for various applications. The fluid is then directed into the throat portion 14 via a funnel-like or other converging exit 21. The throat portion 14 provides a duct of substantially constant profile (normally circular) through its length through which the fluid (liquid) is forced. The expansion portion 16 provides an expanding tube-like member wherein the diameter of the fluid pathway 20 progressively increases between the throat portion 14 and the outlet portion 18. The actual profile of the expansion portion can depend upon the actual fluid used. The outlet portion 18 provides a region where the fluid exiting the nozzle 11 can mix with other fluids (e.g., refrigerants) at ambient conditions, for example, and thereafter be conveyed away. In use, when a liquid working fluid enters the throat portion 14, it is caused to accelerate to an increased speed. The pressure and diameter of the throat orifice may be selected so that the speed of the working fluid at the entry of the throat orifice is approximately the speed of sound (Mach 1).

In some embodiments, the acceleration of the fluid through the nozzle 11 causes a sudden drop in pressure which results in cavitation, in some cases commencing at the boundary between the funnel-like exit 21 of the inlet portion 12 and the entry to the throat orifice 14, and in some cases also being triggered along the wall of the throat orifice. Cavitation results in bubbles containing fluid in the vapor phase being present within the fluid, thereby providing a multi-phase (e.g., two-phase) fluid. The creation of such vapor bubbles can require the input of energy for the input of latent heat of vaporization. As a result, cavitation is accompanied by a decrease in temperature of the working fluid. Meanwhile, the reduction in pressure together with the multiphase fluid results in the lowering of the speed of sound with the result that refrigerant exits the throat at supersonic speed of, for example, at least Mach 1.01, 1.1, 1.2, 1.3, 1.4, 1.5, 2, 3, or higher. Within the expansion portion, the pressure continues at a low level and the fluid expands. As a result of the expansion, the flow accelerates further, reaching a speed in the order of at least about Mach 2 or 3 or higher further along the expansion portion.

The nozzle 205a may be any nozzle configured to induce cavitation in the fluid. In some cases, the nozzle 205a, including components of the nozzle 205a, may be selected from systems and structures disclosed in U.S. Provisional Patent Application No. 61/367,830, U.S. patent application Ser. No. 12/876,985, U.S. patent application Ser. No. 12/753,824, U.S. patent application Ser. No. 12/843,834, and U.S. patent application Ser. No. 13/113,626, which are entirely incorporated herein by reference.

In some cases, the first cycle 201 is configured to operate as described in U.S. patent application Ser. No. 12/732,171 and U.S. patent application Ser. No. 12/876,985, which applications are entirely incorporated herein by reference. For instance, the first cycle 201 can operate in the supersonic flow regime of a working fluid.

With reference to FIG. 2, the second cycle 202 includes a pump 206, an ejector 207 (also “eductor,” “injector,” and “venturi” herein) downstream of the pump 206, a fluid separation unit operation 208 (also “fluid separator” herein) downstream of the ejector 207, and a heat exchanger 209 downstream of the fluid separator 208. The heat exchanger 209 is configured to remove heat from a working traversing the fluid flow path of the second cycle 202. The working fluid of the second cycle 202 in some cases is referred to as a motive (or carrier) fluid. Heat removed by the heat exchanger 209 can be transferred to a second fluid, as indicated by the arrows into and out of the heat exchanger 209. The second cycle 202 includes a fluid flow path bringing the pump 206, ejector 207, fluid separator 208 and heat exchanger 209 in fluid communication with one another. The heat exchanger 209 can be used to remove heat from the working fluid traversing the fluid flow path of the second cycle 202.

In some cases, the ejector 207 is a single stage ejector. In other cases, the ejector 207 is a multi-stage ejector, such as a two-stage or three-stage ejector. Each stage can include a suction reservoir and a suction port leading to the suction reservoir. The suction reservoir is in fluid communication with a throat portion of a stage of the ejector 207. The suction reservoir is configured to be brought under vacuum upon the flow of the working fluid (or carrier fluid) through a throat portion of the ejector 207.

The fluid separator 208 is in fluid communication with the reservoir 203 through a fluid flow path having a valve 210. In some situations, the fluid flow path having the valve 210 can include a heat exchanger for removing heat from a fluid directed from the fluid separator 208 to the reservoir 203.

In some embodiments, the system 200 is a cooling system. In the evaporator 205 heat can be transferred from a secondary fluid to the working fluid of the first cycle 201, which can cool the secondary fluid. The cooled secondary fluid can then be used to cool a target location, such as a residential, commercial or industrial location, or otherwise any structure or location having a source of heat. In other embodiments, the system 200 is a heating system. In some cases, the heat exchanger 209 is used to remove heat from the working fluid of the second cycle 202 and transfer heat to a secondary fluid flowing through the heat exchanger 209. The heated secondary fluid can then be used to heat a target location, such as a residential, commercial or industrial location, or otherwise any structure or location adapted to accept heat, such as, for example, having a lower temperature than the fluid in the heat exchanger 209. In other embodiments, the system 200 can function as both a heating and cooling system. In some cases, heat is removed from a secondary fluid flowing in and out of the evaporator 205, which can be used to cool a target location, and heat is added to a secondary fluid flowing in and out of the heat exchanger 209, which can be used to heat a target location. As an alternative, the system 200 can be configured for non-heating and/or cooling applications, such as, for example, water purification (e.g., desalination). In such a case, heat provided by the carrier fluid of the second cycle 202 via the heat exchanger 209 can be directed to the evaporator 205 and transferred to the working fluid of the first cycle 201. In such a case, salt water can be added to the second cycle 202 at a location upstream of the ejector 207, and purified water can be removed from the second cycle 202, such as after the heat exchanger 209. The second cycle 202 may therefore not operate in a circulatory fashion.

In some embodiments, the second cycle 202 is an absorption loop that can lower the pressure in the reservoir 203. By lowering the pressure, the pressure of the first cycle 201 and, in some cases, the system 200, can be decreased and the temperature can be lowered. By lowering the temperature, the coefficient of performance (“COP”) of the system can be increased.

In some embodiments, coefficient of performance (COP) is defined as evaporator (or nozzle) cooling or heating power (or capacity) divided by pump or compressor power. Generally, the higher the COP, the more efficient the cooling or heating performance of the system 200.

In some embodiments, the system 200 of FIG. 2 can have a COP of at least about 1, or at least about 2, or at least about 3, or at least about 4, or at least about 5, or at least about 6, or at least about 7, or at least about 8, or at least about 9, or at least about 10, or at least about 20, or at least about 30, or at least about 40, or at least about 50, or at least about 60, or at least about 70, or at least about 80, or at least about 90, or at least about 100, or more.

The system 200 of FIG. 2 can be configured for low noise operation. In some embodiments, sound emitted by the system 200 can be between about 10 and 80 decibels, or between about 30 and 70 decibels, or between about 50 and 60 decibels, though in some cases sound emitted by the system 200 can be lower than about 70 decibels, 60 decibels, 50 decibels, 40 decibels, 30 decibels, 20 decibels, 10 decibels, or lower. In other embodiments, sound emitted by the system 200, as measured at a distance of at least about 0.5, or 1, or 2, or 3, or 4, or 5 feet from the system, can be between about 10 and 80 decibels, or between about 30 and 70 decibels, or between about 50 and 60 decibels, though in some cases sound emitted by the system 200 can be lower than about 70 decibels, 60 decibels, 50 decibels, 40 decibels, 30 decibels, 20 decibels, 10 decibels, or lower.

In some embodiments, sound emitted by the system 200 can be at most about 10 decibels, or at most about 15 decibels, or at most about 20 decibels, or at most about 25 decibels, or at most about 30 decibels, or at most about 35 decibels, or at most about 40 decibels, or at most about 45 decibels, or at most about 50 decibels, or at most about 55 decibels, or at most about 60 decibels, or at most about 65 decibels, or at most about 70 decibels. In other embodiments, sound emitted by the system 200 of FIG. 2, as measured at a distance of at least about 0.5, or 1, or 2, or 3, or 4, or 5 feet from the system, may be at most about 10 decibels, or at most about 15 decibels, or at most about 20 decibels, or at most about 25 decibels, or at most about 30 decibels, or at most about 35 decibels, or at most about 40 decibels, or at most about 45 decibels, or at most about 50 decibels, or at most about 55 decibels, or at most about 60 decibels, or at most about 65 decibels, or at most about 70 decibels. The system 200 of FIG. 2 may include one or more sound attenuation enclosures, one or more low noise or substantially low noise pumps, or both. The enclosure can have a cross-sectional area less than about 100 m², 80 m², 60 m², 40 m², 20 m², 15 m², 10 m², 5 m², 2 m², 1 m², 0.5 m², or 0.1 m².

With reference to FIG. 2, in some embodiments, the ejector 207 is a pump-like device that includes a converging-diverging nozzle. The ejector 207 can use the Venturi effect to convert the pressure energy of a motive fluid (e.g., liquid or gas) to velocity energy, which creates a low-pressure zone that draws in and entrains a suction fluid. The suction fluid mixes with the motive fluid to yield a mixed fluid. After passing through a throat of the ejector 207, the mixed fluid expands and the velocity of the mixed fluid decreases, resulting in recompressing the mixed fluid by converting velocity energy back into pressure energy, which causes a rise in pressure. The mixed fluid then condenses due at least in part to the rise in pressure. The motive fluid may be a liquid, steam or any other gas. The entrained suction fluid may be a gas, liquid, slurry (or solid-containing substance) or dust-laden gas stream. In some cases, the ejector 207 can be as described in U.S. Pat. No. 5,526,872 to Gielda et al. (“AIRFLOW EJECTOR FOR AN AUTOMOTIVE VEHICLE”) and Australian Provisional Patent Application Serial No. 2010901506, which are entirely incorporated herein by reference.

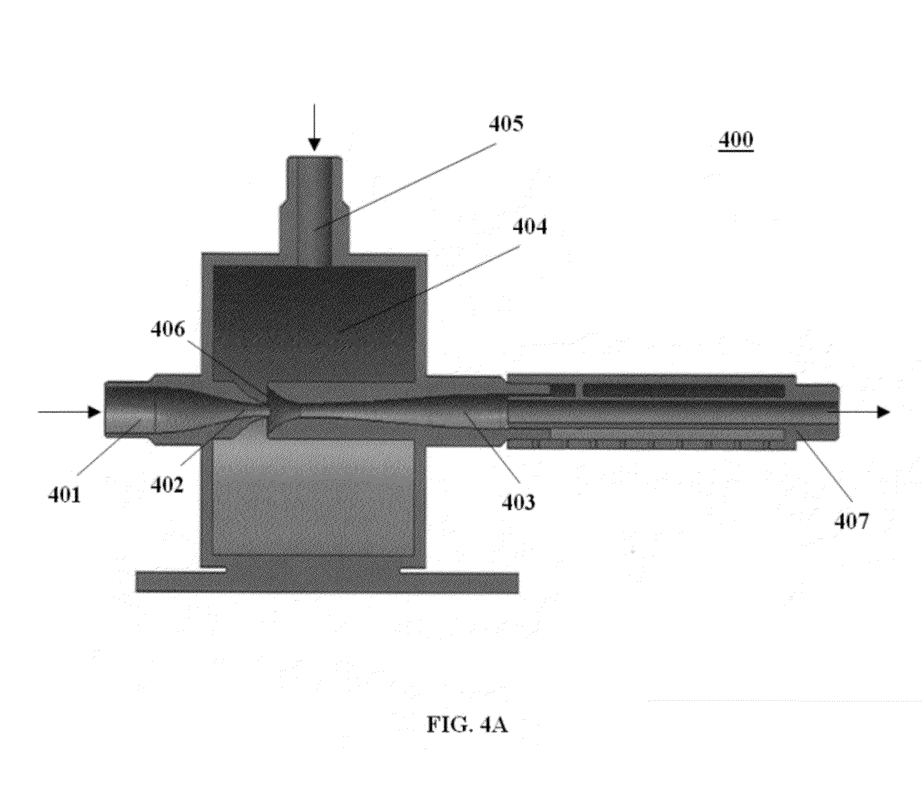

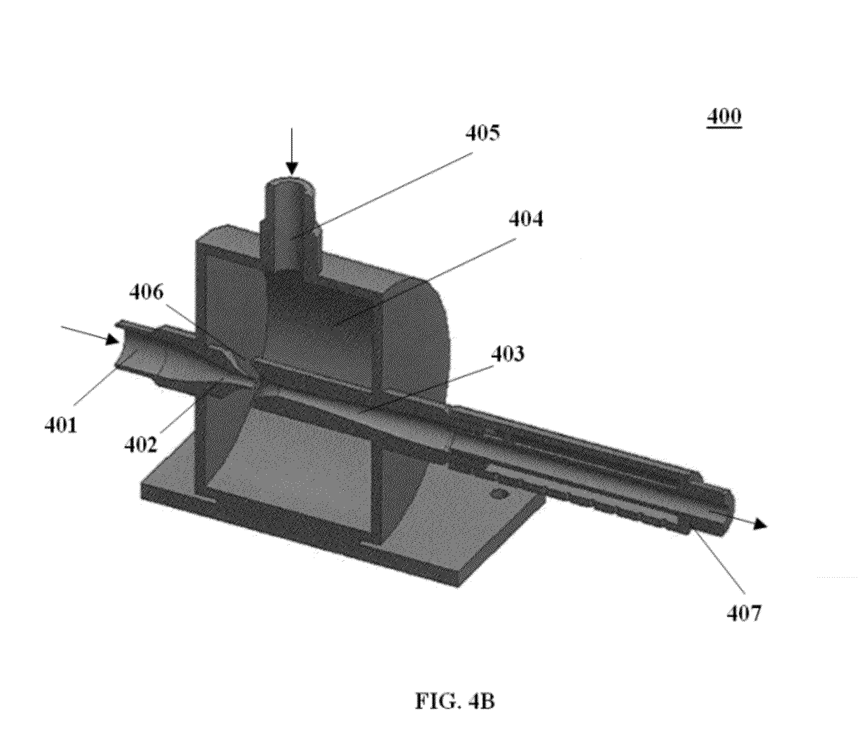

FIGS. 4A and 4B illustrate an ejector 400, in accordance with an embodiment of the invention. In some cases, the ejector 400 can be the ejector 207 of the system 200 of FIG. 2. The ejector 400 includes an inlet 401, throat 402, and outlet 403. The inlet is configured to accept a motive (or carrier) fluid. The ejector 400 includes a suction fluid reservoir (also “suction reservoir” herein) 404 configured to hold a suction fluid, and an inlet 405 for the suction fluid. When used in the system 200, the inlet 405 can be in fluid communication with the reservoir 203 of the first cycle 201. The general direction of fluid flow is indicated in FIGS. 4A and 4B by arrows.

With reference to FIGS. 4A and 4B, the throat 402 includes an inlet 406 for directing a fluid from the suction reservoir 404 into the throat 402. The inlet 406 can include a low-pressure zone that draws in and entrains a fluid from the suction reservoir 404. During operation, a first fluid enters the inlet 401 and flows to the throat 402, at which point it mixes with a second fluid from the suction reservoir 404. The first fluid can be a carrier fluid and the second fluid can be a suction fluid. In some cases, the carrier (or motive) fluid and suction fluid are different fluids. In other cases, the carrier (or driver) fluid and suction fluid are the same fluid (e.g., both the carrier fluid and the suction fluid are water or a refrigerant). After passing through the throat of the ejector 400, the mixed first and second fluids expand. In some situations, upon expansion the velocity of the mixed fluid is reduced, resulting in recompressing the mixed fluid by converting velocity energy into pressure energy. The ejector 400 further includes a channel 407 downstream of the throat 402, which can be used to couple the ejector 400 to a fluid flow path leading, for example, to a fluid separator, such as the fluid separator 208 of FIG. 2. The channel 407 can provide one or more condensation surfaces for the mixed fluid in the outlet 403.

In some situations, the first fluid is a liquid, gas, or gas-liquid mixture. The second fluid may be a gas, liquid, slurry (or solid-containing substance) or dust-laden gas stream. In some embodiments, the first and second fluids are immiscible. In some cases, the first fluid (also “carrier fluid”, “motive fluid” or “driver fluid” herein) is an alcohol (e.g., methanol), ketone, aldehyde, or carboxylic acid, and the second fluid (also “suction fluid”) is an oil. In other cases, the first fluid is water or an acid (e.g., linoleic acid), and the second fluid is water or an alcohol (e.g., methanol, ethanol, propanol). The first and/or second fluid can each be selected from a refrigerant, such as, for example, R134a, R125, R245fa, HFE 7000, or R227ea. The first fluid and second fluid in some cases are the same fluid—e.g., both the first and second fluid are water or a refrigerant.

In an example, the first fluid is water and the second fluid is methanol. In another example, the first fluid is water and the second fluid is acetone. In another example, the first fluid and the second fluid are both water or a refrigerant (e.g., R134a).

In some embodiments, the second cycle 202 can include a co-fluid refrigerant, such as, for example (second fluid/first fluid), acetone/water, methanol/water, or methanol/linoelic acid. In some cases, a carrier fluid, such as, for example, linoelic acid or water, may be combined with an alcohol or ketone, to form a co-fluid refrigerant. In some embodiments, the carrier fluid may be insoluble with the alcohol or ketone. In some embodiments, the first fluid has a lower vapor pressure than the second fluid at a select temperature, such as at 0° C. In some cases, the first fluid and second fluid are immiscible.

The fluid separator 208 can be a liquid-liquid separator, a gas-liquid separator, a solid-liquid separator or a gas-solid separator. The fluid separator 208 is configured to separate fluid mixture from the ejector 207 into separate fluid streams. In an embodiment, the fluid separator 208 separates the fluid mixture from the ejector 207 into a first fluid and a second fluid. The first fluid is directed to the heat exchanger 209, and the second fluid is directed to the reservoir 203 of the first cycle 201. The first fluid can be removed from the fluid separator 208 from a lower portion of the fluid separator 208, and the second fluid can be removed from the fluid separator 208 from an upper portion of the fluid separator 208. The upper and lower portions, in such a case, are with respect to a source of gravitational attraction, and the lower portion is closer to ground than the upper portion.

The fluid separator 208 in some cases effects fluid separation with the aid of density separation. That is, a first fluid having a first density and a second fluid having a second density that is lower than the first density are separated on the basis of the difference in density. The first fluid can be removed from the lower portion of the fluid separator 208, and the second fluid can be removed from the upper portion of the fluid separator 208.

In some cases, the fluid separator 208 is configured to facilitate cyclonic separation or gravity separation. The fluid separator 208 can be a cyclonic separator or a gravity separator. Alternatively, the fluid separator 208 can be a distillation column, which can include one or more trays for effecting the separation of a fluid mixture into individual components. In the case of a distillation column, the fluid separator 208 can include a condenser (not shown) and a reboiler (not shown). The separation of fluid in such a case can be on the basis of the boiling points of the first and second fluids. In some cases, the fluid separator 208 can be a reservoir or a fluid flow path (e.g., channel or tube) having a T-junction for separation a fluid stream from the ejector 207 into a fluid stream leading to the ejector 207 and another fluid stream leading to the heat exchanger 209.

In some embodiments, the first cycle 201 is precluded, and the system 200 only includes the second cycle 202. In such a case, the suction fluid is directed along a fluid stream from the fluid separator 208 to a suction port of the ejector 207. In some implementations, a heat exchanger can be in thermal communication with the suction fluid along the fluid stream. The heat exchanger can supply heat to the suction fluid, which in turn can cool a secondary fluid. In some cases, the fluid stream can lead from the fluid separator 208 to a fluid reservoir that is in fluid communication with the suction port of the ejector 207. During use, suction fluid is directed from the fluid separator 208 to the fluid reservoir, where it evaporates and enters the suction port of the ejector 207. The suction fluid in the fluid reservoir can be heated with the aid of a heat exchanger. In some cases, the transfer of energy from a secondary fluid to the suction fluid cools the secondary fluid, which can subsequently be employed in cooling applications. The second cycle 202 can be included in an enclosure having a cross-sectional area less than about 100 m², 80 m², 60 m², 40 m², 20 m², 15 m², 10 m², 5 m², 2 m², 1 m², 0.5 m², or 0.1 m².

System and methods provided herein, such as the system of 200 of FIG. 2, including the first cycle 201 and the second cycle 202, can be used in, or in conjunction with, various applications. In some embodiments, systems and methods provided herein may be used for cooling (or condensing) gases (or vapors), or for gas (or vapor) storage, such as methane (CH₄) storage. In other embodiments, systems and methods provided herein may be used for cooling electronic (or semiconductor) chips, such as one or more central processing units (CPUs). In other embodiments, systems and methods provided herein may be used for cooling engines, such as aircraft, jet or helicopter engines; car, motorcycle, bike, scooter, bus, truck or tractor engines; energy storage systems (e.g., a battery); and boat engines. In other embodiments, systems and methods provided herein may be used for cooling homes, office buildings, industrial buildings, factories, enclosures, and/or coolers. In other embodiments, systems and methods provided herein may be used for cooling industrial processes, such as chemical processes making use of one or more heat exchangers and/or chillers, or refineries. In some cases, cooling systems and methods provided herein may be used as heat exchangers for use in cooling fluids in industrial or process settings, such as chillers, coolers and condensers (e.g., condensers for us in distillation columns).

In some embodiments, systems and methods provided herein may be used for heating. In such a case, heat removed from a cooled working fluid may be exchanged for heating purposes, such as, for example, home or building heating, or for generating steam for use in various industrial processes, such as, for example, power generation with the aid of a steam turbine.

In some embodiments, the first cycle 201 may be referred as a cold side cooling system (“cold side system”), or in some cases cold side supersonic cooling system. The first cycle 201 of FIG. 2 can include a supersonic cooling system having a pump for directing a working fluid, such as water, through a fluid flow path. In some implementations, the first cycle 201 can be as described in U.S. patent application Ser. No. 12/732,171 and U.S. patent application Ser. No. 12/876,985, which applications are entirely incorporated herein by reference.

The first cycle 201 can operate in a low noise or substantially low noise fashion, which can be owed, at least in part, to the use of a pump and not other compression equipment, such as a compressor. The first cycle 201 can be provided in an enclosure for enabling the cold side cooling system to operate in a low noise or substantially low noise manner. In some cases, the first cycle 201 is included in an enclosure having a cross-sectional area less than about 100 m², 80 m², 60 m², 40 m², 20 m², 15 m², 10 m², 5 m², 2 m², 1 m², 0.5 m², or 0.1 m². In some embodiments, sound emitted by the cold side system may be between about 10 and 80 decibels, or between about 30 and 70 decibels, or between about 50 and 60 decibels, though in some cases sound emitted by the cold side system can be lower than about 70 decibels, 60 decibels, 50 decibels, 40 decibels, 30 decibels, 20 decibels, 10 decibels, or lower. In other embodiments, sound emitted by the cold side system, as measured at a distance of at least about 0.5, or 1, or 2, or 3, or 4, or 5 feet from the cold side system, may be between about 10 and 80 decibels, or between about 30 and 70 decibels, or between about 50 and 60 decibels, though in some cases sound emitted by the cold side system can be lower than about 70 decibels, 60 decibels, 50 decibels, 40 decibels, 30 decibels, 20 decibels, 10 decibels, or lower.

In some embodiments, sound emitted by the first cycle 201 can be at most about 10 decibels, or at most about 15 decibels, or at most about 20 decibels, or at most about 25 decibels, or at most about 30 decibels, or at most about 35 decibels, or at most about 40 decibels, or at most about 45 decibels, or at most about 50 decibels, or at most about 55 decibels, or at most about 60 decibels, or at most about 65 decibels, or at most about 70 decibels. In other embodiments, sound emitted by the first cycle 201, as measured at a distance of at least about 0.5, or 1, or 2 or 3, or 4, or 5 feet from the first cycle 201, may be at most about 10 decibels, or at most about 15 decibels, or at most about 20 decibels, or at most about 25 decibels, or at most about 30 decibels, or at most about 35 decibels, or at most about 40 decibels, or at most about 45 decibels, or at most about 50 decibels, or at most about 55 decibels, or at most about 60 decibels, or at most about 65 decibels, or at most about 70 decibels. The first cycle 201 can include a sound attenuation enclosure, a low noise or substantially low noise pump, or both. The enclosure can have a cross-sectional area less than about 100 m², 80 m², 60 m², 40 m², 20 m², 15 m², 10 m², 5 m², 2 m², 1 m², 0.5 m², or 0.1 m².

In some embodiments, the first cycle 201 can have a coefficient of performance (“COP”) of at least about 1, or at least about 2, or at least about 3, or at least about 4, or at least about 5, or at least about 6, or at least about 7, or at least about 8, or at least about 9, or at least about 10, or at least about 20, or at least about 30, or at least about 40, or at least about 50, or at least about 60, or at least about 70, or at least about 80, or at least about 90, or at least about 100.

The first cycle 201 can have various configurations. In some cases, the first cycle 201 includes one or more heat exchangers for transferring heat to and from the working fluid traversing a fluid flow path of the first cycle 201.

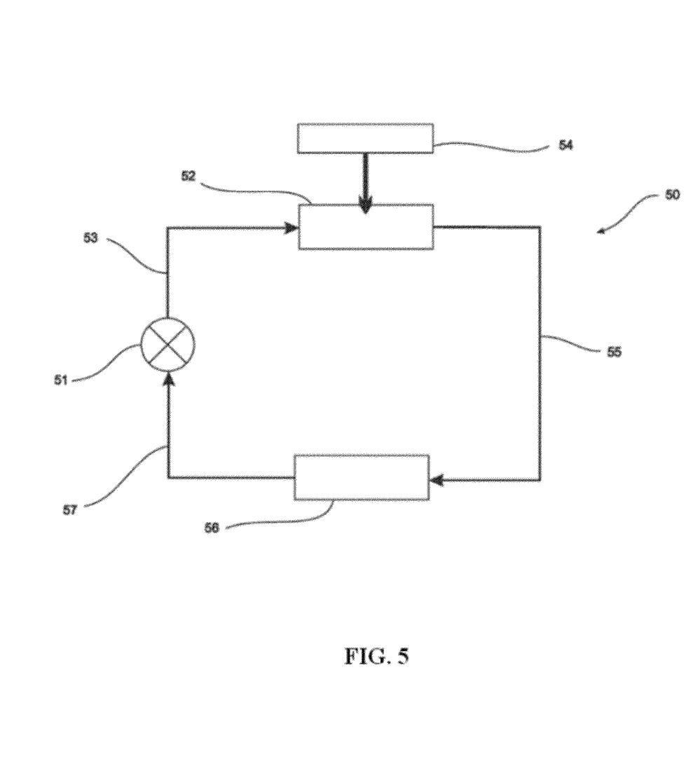

FIG. 5 illustrates a schematic diagram for a system 50, which may be used as the first cycle 201 of FIG. 2. The system 50 includes a positive displacement pump 51, which pumps refrigerant through line 53 to the heat transfer nozzle 52 (nozzle 11). A first heat exchanger 54 receives heat energy from the region to be cooled and transfers that energy to the nozzle 52 at which it is received by the refrigerant during the time during which the refrigerant is in multi-phase.

Within the nozzle 52, a fluid shocks up to ambient conditions. In some cases, the fluid is a multi-phase fluid, comprising a gas-liquid mixture. In some cases, upon shock-up to ambient conditions, heat is transferred to the fluid. The heat transfer method is completed when the fluid (refrigerant) leaves the nozzle 52. The heated refrigerant is then transferred to a reservoir 56 through a line (or fluid flow path) 55. In some cases, the reservoir 56 is the reservoir 203 of FIG. 2. The reservoir 56 may include a heat exchanger where energy absorbed by the fluid is removed. In some cases, the reservoir 56 does not include a heat exchanger, but a heat exchanger (not shown) is disposed between the reservoir 56 and the nozzle 52. The refrigerant is then returned to the pump 51 via line 57.

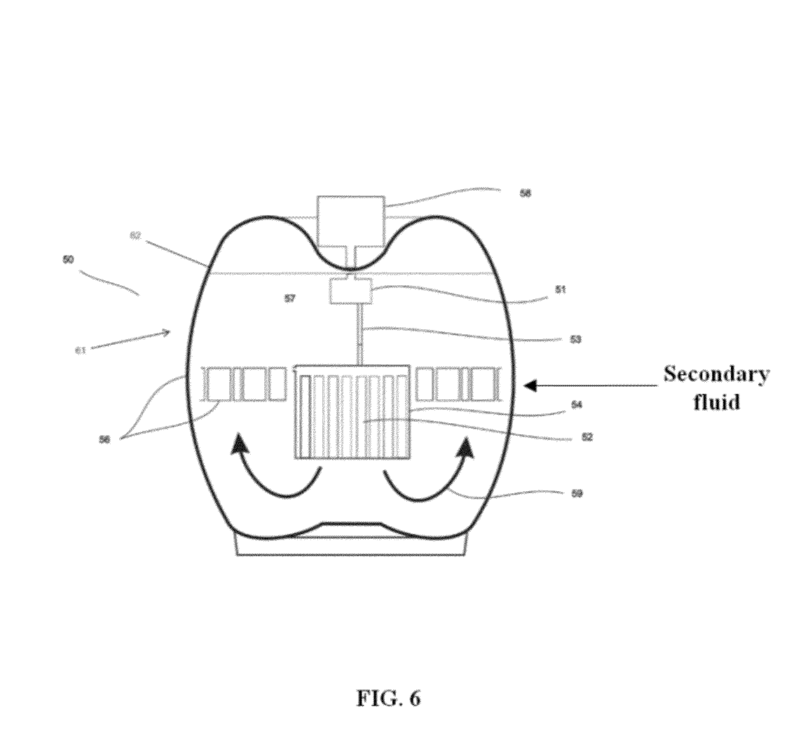

FIG. 6 schematically illustrates a system (or device) 61, as can be used to implement the system 50 of FIG. 5. The system 61 can in some cases be used as the first cycle 201 of the system 200 of FIG. 2. The system 61 may be used in the system 200, such as with the first cycle 201. In FIG. 6, components with the functions described in FIG. 5 are identified with the same numerals. FIG. 6 shows a system 61 including a housing 62 that promotes fluid flow around the housing 62. The pump 51 is located inside the housing 62 near an upper central wall. The pump 51 is driven by a motor 58, which is outside the housing 62 and connects to the pump 51 by an axle (not shown) and that penetrates the housing 62 via a bearing and seal.

In some cases, the system 61 can be sized to provide cooling greater than can be provided with a single heat exchange nozzle, and therefore cooling is achieved by a plurality of heat exchange nozzles arranged in parallel proximate the central region of the housing 62. All units can be supplied from a manifold fed from the pump 51.

The housing 62 can store a substantial volume of refrigerant, which may be applicable when water or an alcohol, such as methanol or water, is the refrigerant. As is indicated by arrows 59, refrigerant exits the nozzles into the refrigerant reservoir and then circulates around the housing 62. The walls of the housing 62 become at least part of the second heat exchanger to dispel the heat which is absorbed into the refrigerant in the nozzles. Additional external heat exchangers may be added if necessary in the application.

The system 61 can have various shapes and sizes. In some cases, the system 61 is not shaped as shown in FIG. 6, but is rather shaped to accommodate other units, such as an eductor, fluid separator, another pump and a heat exchanger if the system 61 is coupled to a cycle, such as a cycle described in the context of FIG. 2.

In the system 61 of FIG. 6, a fluid refrigerant, such as refrigerant R-134a, methanol, or water, can be utilized. The heat transfer nozzle 11 of FIG. 3 may be adapted for use with various refrigerants currently available, and there are applications where other refrigerants besides water can be used. The rate of expansion of the expansion portion can be selected appropriately for any given refrigerant selection.

During use, the expansion of the fluid in the nozzle 52 effects a decrease in temperature of the fluid, which can be used a secondary fluid that is brought in thermal communication with the nozzle 52. In some embodiments, as the fluid leaves the nozzle 52, the pressure of the fluid shocks up to an elevated pressure, such as ambient pressure. The pressure shock-up is accompanied by an increase in temperature of the fluid. Energy can be removed from the fluid with the aid of a heat exchanger downstream of the nozzle 52 or, in some cases, a reservoir in fluid communication with the nozzle 52, such as the reservoir 203 of FIG. 2.

In some cases, the volumetric expansion of a working fluid, such as R-123a and R-134a, are less than that of water, and it may be preferable to reduce the rate of expansion in the expansion portion. For R-134a refrigerants, the expansion half-angle (the angle between the central axis of the nozzle and the wall of the expansion portion) may be on the order of at least about 0.1°, 1°, 2°, 5°, or 10°. In an example, the half-angle for R-134a is on the order of at least about 1°. For R-123a, on the other hand, the half-angle may be on the order of at least about 0.5°, 5°, or 10°. In an example, the half-angle for R-123a is on the order of at least about 5°. For water, the half-angle can be larger than that for R-134a and R-123a. In some cases, the half-angle for water is on the order of at least about 5°, 10°, 15°, or 20°. A nozzle as may be suitable for R-134a is described in U.S. patent application Ser. No. 12/876,985, which is entirely incorporated herein by reference.

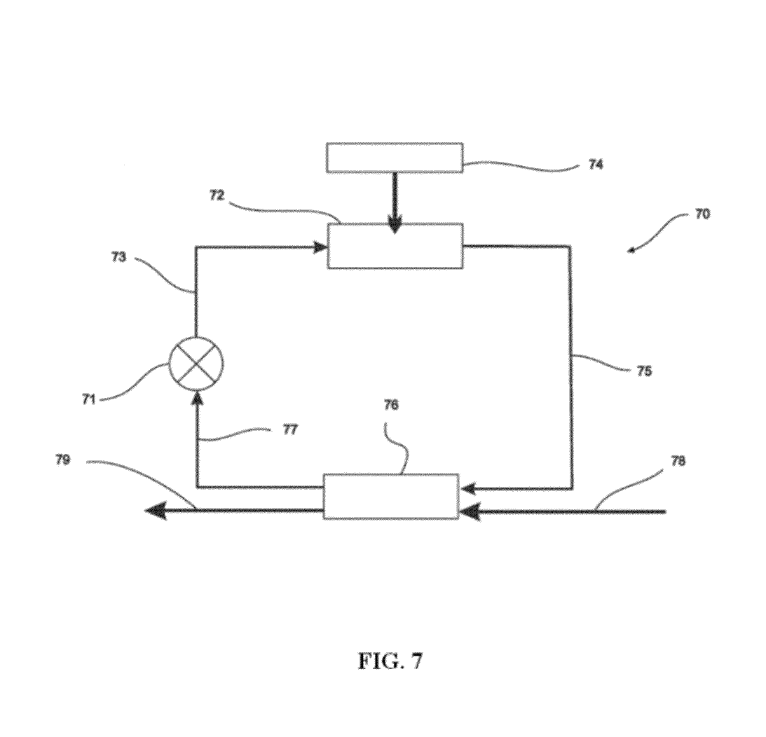

FIG. 7 illustrates a circulatory fluid flow system 70, in accordance with an embodiment of the invention. The direction of fluid flow is indicated by the arrows. The system 70 can be used, in some cases, in water heating purposes, cooling purposes, or both heating and cooling purposes. The system 70 can be used with the system 200 of FIG. 2. For instance, the system 70 can be adapted for use as the first cycle 201.

The system 70 includes a pump 71, an evaporator 72, a heat exchanger 74 coupled to the evaporator 72, a fluid reservoir 76, an inlet 78 for a secondary fluid, and an outlet 79 for the secondary fluid, a control system (not shown), and fluid flow paths 73, 75, and 77, which can be piping. In some cases, the evaporator 72 includes one or more nozzles. In an example, the evaporator 72 includes a plurality of nozzles in parallel.

The system 70 can be configured for use with water as the working fluid. The fluid reservoir 76 can be for storing a heated fluid, such as heated water. The secondary fluid in some cases is water, though other secondary fluids may be used. In some cases, the secondary fluid is an alcohol, aldehyde, ketone, carboxylic acid, or hydrocarbon. In an example, the secondary fluid is methanol, ethanol, or propanol.

In some cases, the system 70 is used as the first cycle 201 of the system 200 of FIG. 2. In such a case, the reservoir 76 is the reservoir 203, which is coupled to the second cycle 202. The system 200 can be used in heating applications. Heat generated by the first cycle 201 can be transferred to the second cycle 202 by way of the reservoir 203. Heat is subsequently transferred to the working (or motive) fluid of the second cycle 202 through the ejector 207. Heat transferred to the second cycle 202 is subsequently transferred to a secondary fluid in the heat exchanger 209. In cases in which the system 200 is for use in water heating applications, the secondary fluid can be water, and the heat exchanger 209 can be used to generate hot water.

There are various alternatives and modifications to the system 200 of FIG. 2. In some embodiments, the first cycle 201 of the system 200 can include more than one evaporator. In some cases, the first cycle 201 can include at least 2, 3, 4, 5, 6, 7, 8, 9, 10, 20, 30, 40, 50, 100, or more evaporators. Each evaporator can include one or more nozzles. In some cases, the evaporators are disposed in a parallel configuration.

In some embodiments, the second cycle 202 of the system 200 can include more than one ejector. In some cases, the second cycle 202 can include at least 2, 3, 4, 5, 6, 7, 8, 9, 10, 20, 30, 40, 50, 100, or more ejectors. The ejectors can be in fluid communication with one another, in some cases in a serial configuration.

In some cases, the cycle 200 can include multiple stages, with each state having a pump, evaporator and reservoir operatively coupled to an ejector. This can permit an increase in temperature of a fluid circulating through the second cycle 202, which may be used for heating purposes.

### Operation of the First Cycle and Second Cycle

In some embodiments, the first cycle 201 operates by a) isenthalpically (i.e., constant enthalpy) increasing the pressure of a working fluid, b) isenthalpically decreasing the pressure of the working fluid, c) increasing the enthalpy of the working fluid at constant pressure, d) isenthalpically increasing the pressure of the working fluid (“pressure shock-up”), and e) decreasing the enthalpy of the working fluid at constant pressure. In some cases, during at least a portion of the increase in enthalpy of the fluid at constant pressure and the isenthalpic increase in pressure, the fluid is travelling at a velocity greater than or equal to the speed of sound.

In some embodiments, during the operation of the second cycle 202 of FIG. 2, a working fluid is directed through a fluid flow path, including the pump 206, ejector 207, fluid separator 208 and heat exchanger 209. The working fluid directed through the ejector 207 can be referred to as a “motive fluid.”

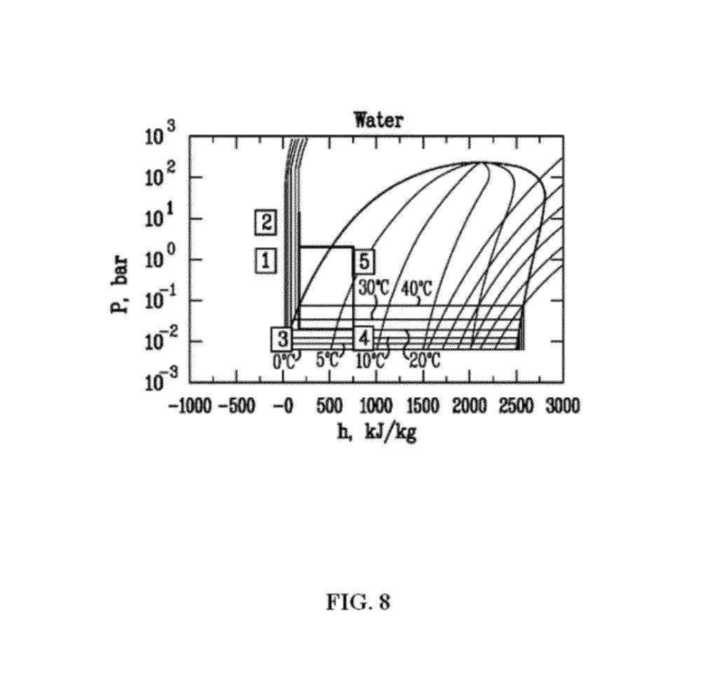

FIG. 8 is a pressure-enthalpy plot for the first cycle 201, in accordance with an embodiment of the invention. From step 1 to 2 in FIG. 8, using the pump 204 a working fluid of the first cycle 201 is pressurized to an elevated pressure, such as a pressure of at least about 0.1 bar, 0.5 bar, 1 bar, 2 bar, 3 bar, 4 bar, 5 bar, 10 bar, 20 bar, 50 bar, 100 bar, or higher. In an example, the working fluid is pressurized to a pressure between about 1.5 bar and 2.5 bars. The working fluid can be pressurized with the aid of a positive displacement pump. The pump power is defined Q*Δ, where ‘Q’ is the volumetric flow rate and ‘ΔP’ is the pressure rise across the pump. In cases in which the working fluid is water, the volumetric flow rate for liquid water can be orders of magnitude less than the water vapor, and significant energy can be saved in this phase compared with a vapor compression system. In some embodiments, step 1 to 2 occurs at substantially constant enthalpy.

The working fluid can be selected from organic and inorganic substances, such as one or a combination of water, alcohols, aldehydes, ketones, carboxylic acids, hydrocarbons, or refrigerants, such as, for example, R134a, R125, R245fa, HFE 7000 or R227ea. In some cases, the working fluid can be a mixed phase working fluid, such as a liquid-solid, liquid-semi solid or liquid-gas mixture. In some cases, a working fluid includes immiscible components, such as water, alcohols, carboxylic acids, aldehydes, ketones and/or hydrocarbons in an oil. In an example, the working fluid is selected from water, alcohol, HFE 7000, R245fa, or combinations thereof, such as, for example, a water-alcohol mixture, water-HFE 7000 mixture, or R245fa.

In some examples, the working fluid circulated through the first cycle 201 is water. In other cases, the working fluid of the first cycle 201 can include a fluid mixture, such as a mixture of organic components. The working fluid can be selected from water, alcohols, aldehydes, ketones, carboxylic acids, and/or hydrocarbons. The working fluid can include an individual components, such as water or an alcohol (e.g., ethanol, propanol), or a mixture of components, such as a methanol-linoleic acid mixture.

With continued reference to FIG. 8, from step 2 to 3, the working fluid flows through the converging-diverging nozzle 205a. In a high speed region, the flow begins to cavitate, resulting in a reduction in the localized speed of sound. The reduction in the localized sound speed can change the character of the flow from incompressible flow to a regime more compatible with high speed nozzle flow. In some embodiments, step 2 to 3 occurs at substantially constant enthalpy.

In some cases, once the flow speed exceeds the local sound speed, the downstream pressure conditions do not propagate upstream. In this condition, the flow can behave like a supersonic nozzle, driving the saturation temperatures down and providing cooling potential.

From step 3 to 4 in FIG. 8, the fluid accelerates. The rapid acceleration of the fluid can be accompanied by a drop in pressure, though in some cases, such as that illustrated in FIG. 8, the pressure of the fluid from step 3 to step 4 is substantially constant. In some cases, as the local static pressure drops, more water vapor is generated from the surrounding liquid. As the fluid passes below the saturation line, a cold sink for cooling applications is generated and the flows behaves as an over expanded jet. Once the fluid has collected sufficient heat, and due to frictional losses, the fluid pressure increases. In some cases, the fluid pressure shocks up to a subsonic condition.

In an example, the working fluid is water or a methanol-linoleic acid mixture, which is directed through the nozzle 205a. In the case of methanol-linoleic acid, methanol can boil out of the mixture as it accelerates through the nozzle 205a.

In an example, fluid enters the converging-diverging nozzle 205a at 10 bar and the pressure at the outlet of the nozzle 205a is 1 bar. The fluid accelerates through the throat of the nozzle 205a and begins to cavitate. After the throat of the nozzle 205a, the flow behaves as a supersonic flow due to reduced sound speed and increases in speed and experiences a subsequent further reduction in pressure, resulting in further cooling. Such cooling can be used to cool a secondary fluid in thermal communication with the nozzle 205a. Further downstream the fluid continues to boil and, in the process, absorbing heat from the secondary fluid (in a secondary cycle, such as a heat exchanger), until it reaches a point at which it shocks back to outlet conditions.

With continued reference to FIG. 8, from step 4 to 5 the fluid shocks up to an elevated pressure, which in some cases is the ambient pressure (1 bar). The fluid shock-up in pressure in some cases occurs at substantially constant enthalpy. The fluid is then expelled back into a reservoir, such as the reservoir 203. In an air-conditioning system, the hot fluid ejected from the cooling tubes is mixed with the bulk fluid to further minimize vapor volume.

In some cases, the pressure at the inlet of the nozzle is about 10 bar and the pressure at the reservoir (ambient) is about 1 bar. Through the nozzle the fluid continues to accelerate with increasing cross-sectional area, achieving supersonic flow in the post throat region of the nozzle 205a.

In some cases, most or all of the vapor is condensed in the nozzle 205a. The shock position is controlled by inlet pressure, heat input along the nozzle 205a, and reservoir 203 pressure. Since the flow in the tube is critical/choked, the impact of pressure of the reservoir 203 applies to the shock location and does not impact the operating pressure in the nozzle 205a.

In some embodiments, the pressure of the reservoir 203 (also “backpressure” herein) is reduced with the aid of the second cycle 202. In some situations, the pressure of the reservoir 205a is less than 1 bar, or less than 0.5 bar, or less than 0.1 bar, or less than 0.01 bar, or less than 0.001 bar, or lower. In some cases, the pressure of the reservoir 203 is lower than the vapor pressure of a fluid or fluid mixture in the reservoir 203.

In FIG. 8, at step 5 and returning to step 1, heat added to the fluid is rejected to the ambient environment via the exterior wall surface or through a secondary internal heat exchanger. In other cases, heat is transferred to a second fluid in the reservoir 203, which is directed to the ejector 207 with the aid of suction (vacuum) provided by the ejector 207 upon the flow of a motive (or carrier) fluid through the ejector 207.

In some cases, the working fluid of the first cycle 201 is water. After the water passes along an expansion portion of the nozzle 205a, it “shocks up” to ambient conditions, with most or substantially all of the vapor bubbles collapsing. As a result, the temperature of the water rises. The temperature of water is increased by the energy absorbed from a heat source, such as a secondary fluid in thermal communication with water through a heat exchanger. The secondary fluid is thus cooled and used in cooling applications, for example.

In some embodiments, the working fluid introduced to pump 204 traverses a primary flow path to the evaporator 205. The evaporator 205 can include one or more nozzles 205a, such as a plurality of nozzles in a parallel configuration. The evaporator 205 induces a pressure drop and phase change that results in a low temperature. The working fluid further boils off at evaporator 205. In some cases, the working fluid cools, enabling the working fluid to be used as a coolant to cool a secondary fluid. For example, the working fluid is a liquid, such as water, cooled to a temperature of about 35° F.-45° F.

In some cases, the first cycle 201 operates in the critical flow regime, allowing for establishment of a compression wave. The working fluid is a coolant that exits the evaporator 205 via an evaporator tube, where the fluid is “shocked up” to an elevated pressure, such as to a pressure between about 0.1 bar and 10 bar, or 1 bar and 2 bar, due at least in part to the flow in the evaporator tube being in the critical flow regime. In some cases, the evaporator 205 includes the nozzle 205a or a plurality of nozzles 205a in fluid communication with an evaporator tube in an integrated fashion.

The critical flow rate is the maximum flow rate that can be attained by a compressible fluid as that fluid passes from a high pressure region to a low pressure region (i.e., the critical flow regime). Critical flow allows for a compression wave to be established and utilized in the critical flow regime. Critical flow can occur when the velocity of the fluid is greater than or equal to the speed of sound in the fluid. In critical flow, the pressure of the fluid along a channel may not be influenced by the exit pressure and at the channel exit, and the fluid can “shock up” to the ambient condition. In critical flow, the fluid may also remain at a low pressure and temperature corresponding to a saturation pressure. In some cases, a secondary heat exchanger having a secondary fluid may be used to cool the secondary fluid that is in thermal communication with the fluid flowing through the evaporator.

In some embodiments, the thermodynamics and mechanics of the present systems can be further enhanced through application of nanotechnology, such as for cases in which water or an organic fluid is used as a refrigerant. With the aid of nanotechnology high heat transfer coefficients in the sonic multiphase cooling regime may be achieved. Application of highly conductive nanoparticles to the flow may help increase the effective thermal conductivity and enhance heat transfer rates. Inclusion of nanoparticles, such as in the working fluid or on evaporator surfaces (e.g., surfaces of the nozzle 205a), may provided for improved cavitation phenomena in the throat of the nozzle 205a.

In some cases, the operation of the first cycle 201 can be as described in U.S. patent application Ser. Nos. 12/732,171, 12/753,824, 12/890,940, 12/843,834, 12/876,985, 12/902,056, 12/902,060, 12/960,979, 12/961,015, 12/961,342, 12/961,366 and 12/961,386, which are entirely incorporated herein by reference.

During operation of the second cycle 202, a working fluid (also “carrier fluid” herein), such as water or linoleic acid, is pumped with the aid of the pump 206 through the ejector 207. Upon the flow of the carrier fluid through the ejector 207, a low pressure region is generated in a reservoir (e.g., suction reservoir 404, see FIG. 4) of the ejector 207, which decreases the pressure in the reservoir 203 of the first cycle 201. The pressure of the carrier fluid at the inlet of the ejector 207 can be at least about 1 pound per square inch absolute (psia), 5 psia, 10 psia, 15 psia, 20 psia, 25 psia, 30 psia, or higher, and the pressure in the reservoir 203 can be at least about 0.01 psia, 0.1 psia, 0.2 psia, 0.3 psia, 0.4 psia, 0.5 psia, 1 psia, 2 psia, 3 psia, 4 psia, or 5 psia. In some embodiments, the pressure in the reservoir 203 is less than the pressure at the inlet of the ejector 207. In an example, the pressure at the inlet of the ejector 207 is about 30 psia, and the pressure in the reservoir 203 is about 1.4 psia.

The reservoir 203 includes a mixture of a working fluid that is directed through the first cycle 201, and a suction fluid that is directed to the ejector 207. The suction generated by the ejector 207 draws the suction fluid into the ejector 207 (e.g., into a suction reservoir of the ejector 207), which mixes with the carrier (or motive) fluid of the second cycle 202 to form a mixed fluid. The ejector 207 includes a region of minimum cross-sectional area, which effects an increase in pressure of the mixed fluid. The high pressure of the fluid beyond the minimum cross-section area of the ejector 207 causes the suction fluid to condense, which can add sensible heat to the carrier fluid and raise the temperature of the carrier fluid, in some cases above ambient conditions (e.g., 25° C.).

In an example, the reservoir 203 contains a mixture of linoleic acid and methanol. Linoleic acid is pumped through the first cycle 201, and methanol is directed to the second cycle 202 as a suction fluid of the ejector 207. During the operation of the system 200, a low pressure is generated in the reservoir 203, which aids in the evaporation of methanol. Methanol then flows from the reservoir 203 to the ejector 207. The evaporation of methanol effects a decrease in the temperature of the reservoir 203. In some situations, upon the evaporation of methanol, the pressure in the reservoir 203 decreases. The decreased pressure in the reservoir 203 provides a lower back pressure (also “backpressure” herein) in the first cycle 201, which can aid in improving the performance (e.g., COP) of the first cycle 201 and in some cases the system 200.

In the ejector 207, methanol vapor is entrained in the flow of fluid through the ejector 207 of the second cycle 202. In some cases, the carrier (or motive) fluid of the second cycle 202 is linoleic acid, and methanol is entrained in the flow of linoleic acid through the ejector 207. The high pressure of the fluid beyond the minimum cross-section area of the ejector 207 causes methanol to condense, which can add sensible heat to the linoleic acid and raise the temperature of the fluid, in some cases above ambient conditions (e.g., 25° C.).

Following the ejector 207, the mixture of the carrier fluid and suction fluid (e.g., linoleic acid and methanol, respectively) is separated with the aid of the fluid separator 208. In some embodiments, the fluid separator 208 is configured to effect the separation of immiscible fluids. In an example, the fluid separator 208 is a cyclonic separator or gravity separator.

Next, the suction fluid from the fluid separator 208 is directed to the reservoir 203. In some cases, the flow of the suction fluid from the fluid separator 208 to the reservoir is regulated with the aid of the valve 210. For instance, the valve 210 can be opened to allow the suction fluid to flow from the fluid separator 208 to the reservoir 203. The opening and closing of the valve 210 can be regulated by a feedback control system.

In some cases, heat that was added to the carrier fluid from the condensation of the suction fluid can be removed with the aid of the heat exchanger 209. In an example, heat added to the linoleic acid carrier fluid from the condensation of methanol can be removed by the heat exchange 209. In some cases, the heat exchanger 209 is a fluid-to-fluid heat exchanger, such as an air-to-fluid or fluid-to-air heat exchanger. In other cases, the heat exchanger 209 includes heat fins and heat transfer to a secondary fluid, such as air, is convective. Heat from the carrier fluid can be transferred to a secondary fluid, which can be used for heating purposes, such as heating systems (e.g., water heater). In an example, air at ambient conditions (e.g., 25° C.) is driven over the heat exchanger to cool the linoleic acid stream.

Next, the carrier fluid is directed to the pump 206. In some cases, the pump 206 increases the pressure of the carrier fluid to at least about 1 psia, 5 psia, 10 psia, 15 psia, 20 psia, 25 psia, 30 psia, or higher. In an example, the pump 206 raises the pressure of linoleic acid to about 30 psia. The pressurized carrier fluid is then directed to the ejector 207.

In some embodiments, the system 200 of FIG. 2 can be configured to operate at a temperature between about −20° C. and 100° C., or −10° C. and 50° C., or 0° C. and 5° C.

In some embodiments, the system 200 of FIG. 2 can operate at low pressures, such as pressure not exceeding 50 psia, 40 psia, 30 psia, 20 psia, 10 psia, or 1 psia. The system 200 can utilize a co-fluid refrigerant. In some embodiments, the system 200 can have a coefficient of performance (COP) greater than or equal to 1, or 2, or 3, or 4, or 5, or 6, or 7, or 8, or 9, or 10, or 15, or 20, or 30, or 40, or 50, or 60, or 70, or 80, or 90, or 100, or higher.

In some embodiments, the carrier fluid can be selected from one or more of water, alcohols, ketones, aldehydes, carboxylic acids and hydrocarbons, and the suction fluid can be selected from one or more of water, alcohols, ketones, aldehydes, carboxylic acids and hydrocarbons. In some situations, the fluids are selected such that the suction fluid has a higher vapor pressure than the carrier fluid at a given temperature. In an example, the carrier fluid water and the suction fluid is a hydrocarbon. In another example, the carrier fluid is water and the suction fluid is a refrigerant, such as, for example R134a, R125, R245fa, HFE 7000, R227ea or combinations thereof.

The system 200 can include a controller (or control system) 211 operatively coupled to the system 200, including various components of the system 200, sensors used to measure operating parameters, and/or valves used to provide feedback control for the system 200. For instance, the controller 211 can be in communication (dashed lines) with the pumps 204 and 206 and configured to control the pumps 204 and 206, such as, for example, to regulate fluid pressure and flow rate. The controller can include one or more memory locations for storing machine executable code, and one or more processor for executing the machine executable code. The machine executable code can implement the methods described herein. A processor can be a central processing unit (CPU). A memory location can be selected from random access memory (RAM), read-only memory (ROM), optical-recording media and/or magnetic recording media.

### Serial Ejectors

In another aspect of the invention, a heating and/or cooling system comprises a first cycle and a second cycle. The first cycle includes a pump leading into a plurality of evaporators in parallel, with each evaporator directly downstream of the pump. Each evaporator is configured to facilitate a supersonic shock-up of fluid pressure. An evaporator is in fluid communication with a fluid reservoir downstream of the evaporator. The second cycle includes a pump, a plurality of ejectors downstream of the pump, and a heat exchanger downstream of the plurality of ejectors. The pump is disposed downstream of the heat exchanger. The plurality of ejectors are disposed in a serial configuration, i.e., one after another along a fluid flow path of the second cycle.

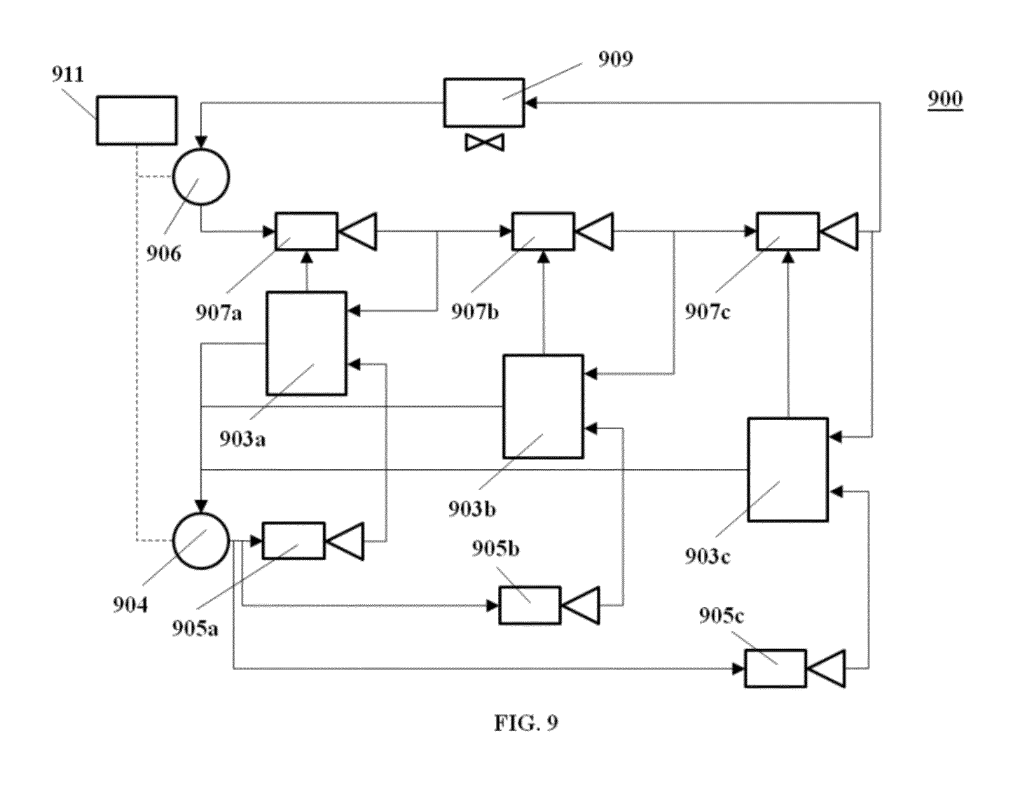

FIG. 9 shows a fluid flow system 900 having a plurality of ejectors in series and a plurality of evaporators in parallel, in accordance with an embodiment of the invention. The system 900 can be used in heating and/or cooling applications. The system 900 includes a first reservoir 903a in fluid communication with a first ejector 907a, a second reservoir 903b in fluid communication with a second ejector 907b, and a third reservoir 903c in fluid communication with a third ejector 907c. The first reservoir 903a, second reservoir 903b and third reservoir 903c are in fluid communication with a first pump 904. In some cases, the first reservoir 903a, second reservoir 903b and third reservoir 903c are in fluid communication with suction reservoirs of the first ejector 907a, second ejector 907b and third ejector 907c, respectively. The first pump 904 is in fluid communication with a first evaporator 905a, second evaporator 905b and third evaporator 905c. The evaporators 905a-905c each include one or more nozzles, which can be converging-diverging nozzles. In some cases, the nozzles are configured to induce cavitation of a working fluid flowing through the nozzles.

The ejectors 907a-907c are in fluid communication with a second pump 906 and a heat exchange 909. The heat exchanger is configured to transfer heat to or from a working fluid flowing through the second pump 906 and the ejectors 907a-907c.

The first pump 904, evaporators 905a, 905b and 905c and reservoirs 903a, 903b and 903c are included in a first cycle. The second pump 906, ejectors 907a, 907b, and 907c and heat exchanger 909 are included in a second cycle. The first and second cycles each include a fluid flow path. The first and second cycles are in fluid communication with one another through the reservoirs 903a, 903b and 903c.

During use, a motive fluid is directed from the pump 906 to the first ejector 907a. In the first ejector 907a, the motive fluid is mixed with a suction fluid from the first reservoir 903a to form a first mixed fluid. The first mixed fluid is then directed to the second ejector 907b through a first stream leading from the first ejector 907a to the second ejector 907b. A portion of the first stream is directed to the first reservoir 903a. The remainder of the first stream is directed to the second ejector 907b, where it is mixed with a suction fluid from the second reservoir 903b to form a second mixed fluid. The second mixed fluid is then directed to the third ejector 907c. A portion of a second stream having the second mixed fluid and leading from the second ejector 907b to the third ejector 907c is directed to the second reservoir 903b. The remainder of the second stream is directed to the third ejector 907c, where it is mixed with a suction fluid from the third reservoir 903c to form a third mixed fluid. The third mixed fluid is then directed to the heat exchanger 909. A portion of a third stream having the third mixed fluid and leading from the third ejector 907c to the heat exchanger 909 is directed to the third reservoir 903c. The remainder of the third stream is directed to the heat exchanger 909.

In some situations, the second cycle can include one or more fluid separators (not shown) for facilitating the separation of a fluid mixture. The fluid separators can be similar, if not identical, to the fluid separator 208 described above in the context of FIG. 2. In an example, the second cycle includes a fluid separator between the first ejector 907a and the second ejector 907b, a fluid separator between the second ejector 907b and the third ejector 907c, and/or a fluid separator between the third ejector 907c and the heat exchanger 909. A fluid separator is configured to provide a fluid stream to a reservoir in the first cycle, and another fluid stream to an ejector or the heat exchanger 909.

In some embodiments, a mixed fluid in the reservoirs 903a, 903b and 903c is separated into a first fluid and a second fluid. In some cases, the first fluid has a higher vapor pressure than the second fluid at a select temperature. The first fluid may have a lower density than the second fluid. The first fluid is directed to an ejector and is subsequently mixed with a motive fluid directed through the ejector to form a mixed fluid. The second fluid is directed to the pump 904 and subsequently the evaporators 905a, 905b and 905c.

The first and second fluids are separable in the reservoirs 903a, 903b and 903c can be separable. In some situations, the first and/or second fluids can each include a plurality of fluids. IN an example, the first fluid is methanol or a hydrocarbon, and the second fluid is water or a mixture of water and an acid, such as linoleic acid.

The first fluid and second fluid can each be selected from water, alcohols, ketones, aldehydes, carboxylic acids and hydrocarbons. In some embodiments, the first fluid has a higher vapor pressure than the second fluid at a given temperature. In an example, the first fluid is methanol, ethanol or propanol, and the second fluid is water. In another example, the first fluid has a lower molecular weight than the second fluid. For instance, the first fluid includes methanol or a hydrocarbon (e.g., R-134) and the second fluid includes propanol.

Fluid from the first reservoir 903a, second reservoir 903b and third reservoir 903c is directed to the pump 904, which directs the fluid to the first evaporator 905a, second evaporator 905b and third evaporator 905c. The fluid leaving the pump is pressurized, as described in the context of FIGS. 6-8, for example. The first evaporator 905a, second evaporator 905b and third evaporator 905c are disposed in parallel—that is, each evaporator is directly downstream of the pump 904 and upstream of a reservoir. In some cases, as the fluid passes through the evaporators, the pressure of the fluid isenthalpically decreases, and following an increase in the enthalpy of the fluid, the pressure of the fluid isenthalpically increases (see, e.g., FIG. 8 and the corresponding text). The isenthalpic increase of the pressure of the fluid is accompanied by a pressure shock-up to an elevated pressure, as described elsewhere herein. From the evaporators 905a-905c, fluid is directed to the reservoirs 903a-903c. That is, fluid from the first evaporator 905a is directed to the first reservoir 903a, fluid from the second evaporator 905b is directed to the second reservoir 903b, and fluid from the third evaporator 905c is directed to the third reservoir 903c.

While the system 900 of FIG. 9 includes three ejectors in series and three evaporators in parallel, the system 900 can include any number of ejector and evaporators in parallel. The system 900 can include at least 1, 2, 3, 4, 5, 6, 7, 8, 9, 10, or more ejectors. In cases in which the system 900 has a plurality of ejectors, at least a subset of the ejectors can be in series. The system 900 can include at least 1, 2, 3, 4, 5, 6, 7, 8, 9, 10, or more evaporators. In cases in which the system 900 has a plurality of evaporators, at least a subset of the evaporators can be in parallel.

In some cases, the system 900 includes a single evaporator coupled to the pump 904, as opposed to a plurality of evaporators. The single evaporator in such a case is directed into the reservoirs 903a, 903b and 903c. In some cases, the system 900 includes a single ejector and a plurality of evaporators. The single ejector can be coupled to a plurality of reservoirs that are in turn coupled to the pump 904 and the plurality of evaporators.

In an example, during use the pump 904 can be operated at a pump power of about 126 watts (W), the pump 906 can be operated at a pump power of about 606 W, the heat exchanger 909 is an air-blown fan operating at a power of about 220 W, and the evaporators 905a, 905b and 905c are in fluid communication with an air-blown heat exchanger operating at about 220 W.

The system 900 can include a controller (or control system) 911 operatively coupled to the system 900, including various components of the system 900, sensors used to measure operating parameters, and/or valves used to provide feedback control for the system 900. For instance, the controller 911 can be in communication (dashed lines) with the pumps 904 and 906 and configured to control the pumps 904 and 906, such as, for example, to regulate fluid pressure and flow rate.

Systems and methods provided herein may be combined with, or modified by, other systems and methods, such as and methods disclosed in U.S. Provisional Patent Application Nos. 61/367,830 and 61/433,165; U.S. patent application Ser. Nos. 12/732,171, 12/753,824, 12/890,940, 12/843,834, 12/876,985, 12/902,056, 12/902,060, 12/960,979, 12/961,015, 12/961,342, 12/961,366, 12/961,386; U.S. Pat. Nos. 7,814,967, 7,096,934 and 7,287,590; and PCT/US2010/028761, which are entirely incorporated herein by reference.

### Two-Phase Supersonic Cycle

Another aspect of the invention provides a cooling system having a pump, an ejector downstream of the pump, a first heat exchanger downstream of the ejector, an evaporator downstream of the heat exchanger and a fluid separator downstream of the nozzle. In some cases, a second heat exchanger is disposed downstream of the fluid separator.

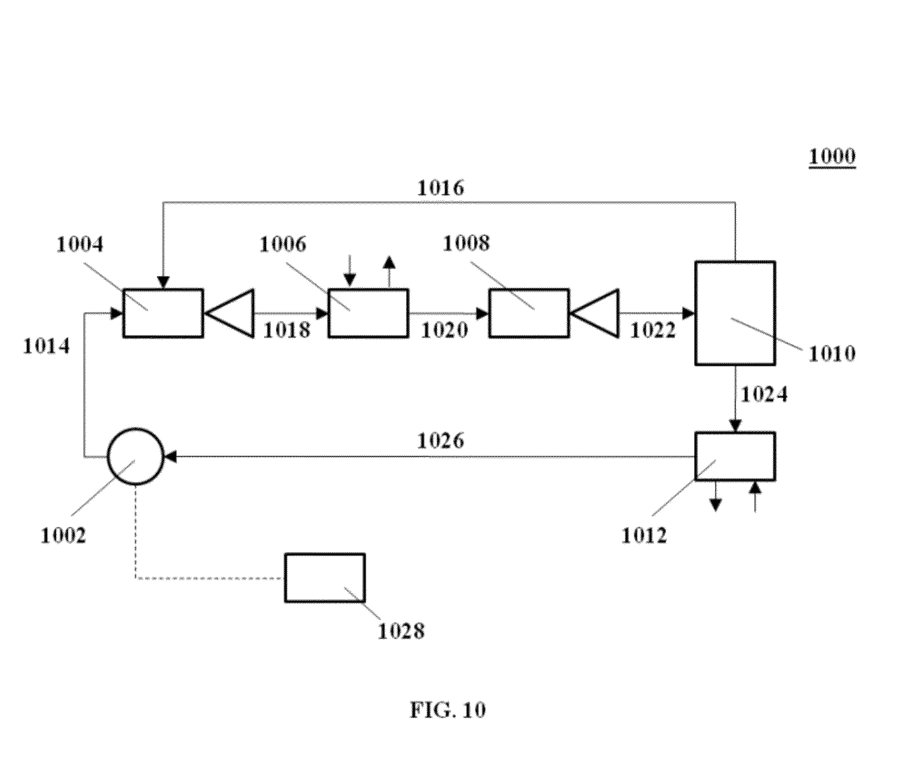

FIG. 10 shows a fluid flow system 1000, in accordance with an embodiment of the invention. The system 1000 can be used in heating and/or cooling applications. The system 1000 can be a single phase system or a multi phase system, such as a two phase system. The system 1000 includes a pump 1002, an ejector 1004, a first heat exchanger 1006, an evaporator 1008, a fluid separator 1010, and a second heat exchanger 1012. Components (or “unit operations”) of the system 1000 can be interconnected with the aid of streams, which can include fluid passages or conduits for aiding in fluid flow from one unit operation to another. The evaporator 1008 can be a converging-diverging nozzle, as described above in the context of FIG. 3. The ejector 1004 can be as described above in the context of FIGS. 4A and 4B. The system 1000 is configured to operate with a carrier fluid passing through the ejector 1004, and a suction fluid directed to a suction reservoir of the ejector 1004 upon the flow of the carrier fluid through the ejector 1004. In some cases, the carrier fluid has a lower vapor pressure than the suction fluid at a select temperature. In an example, the carrier fluid is water and the suction fluid is methanol. In another example, the carrier fluid is water and the suction fluid is acetone. The first heat exchanger 1006 and second heat exchanger 1012 can be liquid-liquid or liquid-gas (e.g., liquid-air) heat exchangers.

During use, the pump 1002 pressurizes the carrier fluid, which is directed to the ejector 1004 through stream 1014. The suction fluid is directed to a suction reservoir of the ejector 1004 through stream 1016 and is mixed with the carrier fluid to form a mixed fluid, as described above. The mixed fluid moves through a throat of the ejector 1004 and experiences an increase in pressure, which causes the suction fluid to condense and transfer heat to the carrier fluid. The mixed fluid is then directed to the first heat exchanger 1006 via stream 1018. In the first heat exchanger 1006 the mixed fluid is cooled and subsequently directed to the evaporator 1008 via stream 1020.

In the evaporator 1008 the pressure of the fluid is decreased. In some cases, the evaporator 1008 is a nozzle that operates as described above in the context of FIG. 8. The evaporator 1008 can be a converging-diverging nozzle. In some cases, in the evaporator 1008 the fluid undergoes an isenthalpic decrease in pressure followed by an increase in energy at constant pressure. The fluid can flow through at least a portion of the evaporator 1008 at a velocity greater than or equal to the speed of sound. In an example, the velocity of the mixed fluid through at least a portion of the evaporator 1008 is supersonic. As the mixed fluid passes through the evaporator 1008, heat is added to the mixed fluid through a secondary fluid that is in thermal communication with the evaporator 1008, such as, for example, air or an organic substance, such as water, an alcohol, an aldehyde, a ketone, a carboxylic acid, a hydrocarbon, or a combination thereof. The evaporator 1008 can thus function as a heat exchanger.

In some cases, as the mixed fluid passes through the evaporator 1008, the suction fluid is vaporized, which creates a cold, two-phase flow region in the evaporator 1008, with the suction fluid being in the gas phase and the carrier (or motive) fluid being in the liquid phase. This draws heat into the evaporator 1008, which is transferred to carrier fluid. The velocity of the mixed, two-phase fluid through at least a portion of the evaporator 1008 is greater than or equal to the speed of sound. In some cases, the velocity is supersonic.

From the evaporator 1008 the mixed fluid is directed to fluid separator 1010 through stream 1022. In some cases, the evaporator 1008 can be in direct contact with the fluid separator 1010 such that the evaporator 1008 feeds directly into the fluid separator 1010. The fluid separator 1010 can be as described above in the context of FIG. 2. For instance, the fluid separator 1010 effects fluid separation with the aid of density separation or on the basis of a difference in vapor pressure between the carrier fluid and suction fluid. The fluid separator 1010 in some cases is a distillation column (or a plurality of distillation columns). As another example, the fluid separator 1010 is a cyclonic separator or a gravity separator. In some cases, the fluid separator 1010 is a reservoir. A reservoir may be preferable in instances in which no additional processing is required to separate the mixed fluid into component streams, such as, for example, if the suction fluid enters the reservoir in the gas phase and the carrier fluid enters the reservoir in the liquid phase. A reservoir may also be used in cases in which the density difference between the suction fluid and carrier fluid is such that the carrier fluid and suction fluid can separate without any additional processing.

The flow of the suction fluid out of the fluid separator 1010 (e.g., reservoir) can be facilitated with the aid of the suction supplied by the ejector 1004. In some cases, however, a pump can be provided along the stream 1016. In cases in which the fluid separator 1010 is a reservoir, suction from the ejector 1004 can be used to draw the suction fluid out of the mixed fluid in the reservoir, thereby providing the stream 1016 that includes the suction fluid and the stream 1024 that includes the carrier fluid. In some cases, the suction fluid is removed from a top portion of the fluid separator 1010 and the carrier fluid is removed from a bottom portion of the fluid separator 1010.

With continued reference to FIG. 10, the fluid separator 1010 effects the separation of the mixed fluid into the suction fluid, which is directed to the ejector 1004 via stream 1016, and the carrier fluid, which is directed to the second heat exchanger 1012 via stream 1024. The second heat exchanger 1012 is used to remove heat from the carrier fluid.

The second heat exchanger may be used to removed heat from the carrier fluid to minimize or prevent cavitation in the pump 1002. In some cases, the second heat exchanger 1012 is optional. For instance, the operating conditions of the system 1000 may be selected such that no additional heat is required to be removed from the fluid stream leading from the fluid separator 1010 to the pump 1002. The direction of fluid flow during operation of the system 1000 is shown by the arrows. The arrows leading into and out of the heat exchangers 1006 and 1012 illustrate the flow of secondary fluids for use with the heat exchangers 1006 and 1012.

The stream 1024 or 1026 can be in fluid communication with a de-gassing system for removing dissolved gas from the carrier fluid. The de-gassing system in some cases is a deaeration system for removing dissolved air from the carrier fluid.

Although the streams 1016 and 1024 have been described as having the suction fluid and carrier fluid, respectively, the stream 1016 can also include the carrier fluid and the stream 1024 can also include the suction fluid.

The system 1000 can include a controller (or control system) 1028 operatively coupled to the system 1000, including various components of the system 1000, sensors used to measure operating parameters, and/or valves used to provide feedback control for the system 1000. For instance, the controller 1028 can be in communication (dashed line) with the pump 1002 and configured to control the pump 1002, such as, for example, to regulate fluid pressure and flow rate.

### Example

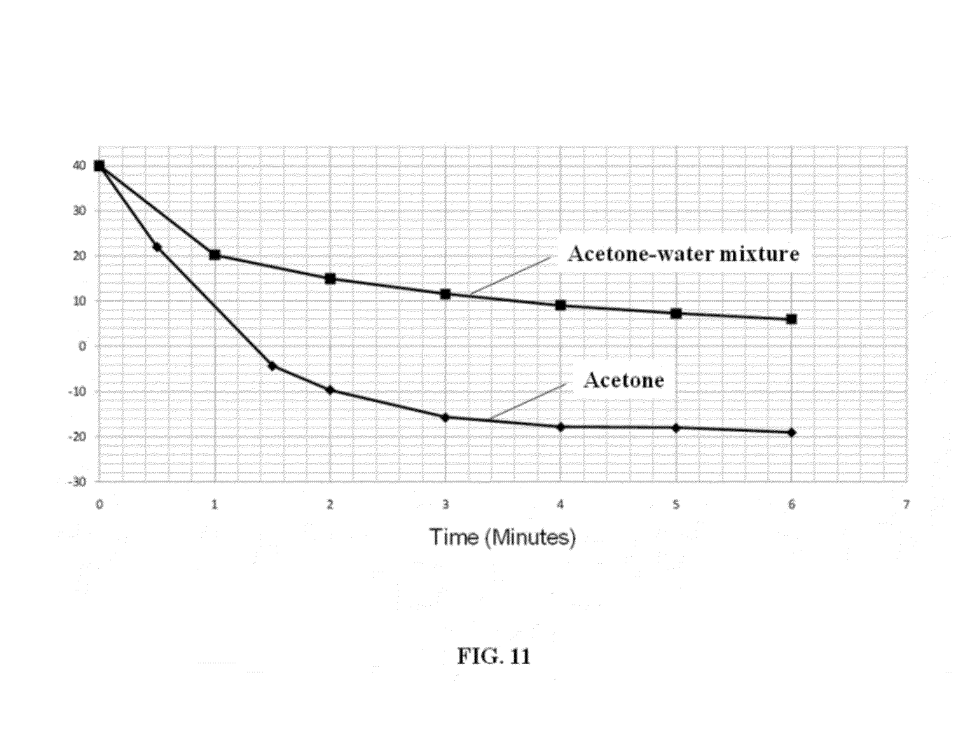

A cooling system, such as the system of FIG. 2 adapted for cooling applications, is used for cooling applications. The cooling system includes a pump, ejector device and reservoir. Two use cases are conducted. In a first case, the reservoir includes pure acetone (bottom plot). In a second case, the reservoir includes a mixture of 30% acetone and 70% water (top plot). The temperature of the reservoir (y-axis) as a function of time (x-axis) in each of the two use cases is shown in FIG. 11. During use, for the acetone-water mixture the temperature of the reservoir decreases from about 40° C. to about 5° C. in about 6 minutes. For pure acetone, the temperature of the reservoir decreases from about 40° C. to about −19° C. in about 6 minutes. The system is able to achieve a cooling rate of about 2.1 kilowatts (kW). The input power to the pump is approximately 35 watts (W) in both use cases.

Although systems and methods provided herein have been described in the context of cooling and/or heating, such systems and methods can be individually or collectively implemented in other contexts. For instance, fluid flow systems can be used as cooling systems for cooling vapor storage vessels, electronics (e.g., processors), motors (e.g., car engines, bike engines, aircraft engines, boat engines), buildings or enclosures (e.g., homes, office buildings, factories), chemical plants and refineries.

As another example, the second cycle 202 of FIG. 2 can be used in a heating or cooling system. In such a case, the first cycle 201 can be precluded, and the second cycle 202 can be used to heat a secondary fluid, such as with the aid of the heat exchanger 209, and/or cool a secondary fluid, such as with the aid of a heat exchanger in thermal communication with a fluid reservoir that is in direct fluid communication with the suction port of the ejector 207 and the fluid separator 208. The fluid reservoir can be the fluid reservoir 203 of FIG. 2, but with the other elements of the first cycle 201 precluded. In such a case, in an example, a fluid stream leads from the fluid separator 208 to the fluid reservoir 203, and another fluid stream leads from the fluid reservoir to a suction port of the ejector 207. The fluid reservoir 203 is configured to receive and hold a suction fluid from the fluid separator 208. For cooling purposes, heat from the secondary fluid is supplied to the suction fluid in the fluid reservoir 203 to evaporate the suction fluid, which is then directed to the ejector 207. The secondary fluid provides at least a portion of the latent heat of vaporization of the suction fluid. The transfer of heat from the secondary fluid to the suction fluid cools the secondary fluid. The cooled secondary fluid can then be used in cooling applications, such as air conditioning or refrigeration systems.

As another example, the second cycle 202 of FIG. 2 can be used in water purification systems, such as water desalination (or desalinization) systems. In such a case, the first cycle 201 can be precluded, and the second cycle 202 can be used to remove salt from salt water. In addition, such water distillation systems can be combined with other unit operations, such as lighting systems (e.g., ultraviolet light systems) for neutralizing or otherwise eliminating pathogens.

Systems and methods provided herein can be implemented with the aid of a control system having one or more memory locations for storing machine executable code, and one or more processor for executing the machine executable code. A processor can be a central processing unit (CPU). A memory location can be selected from random access memory (RAM), read-only memory (ROM), optical-recording media and/or magnetic recording media.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents. It is intended that the following claims define the scope of the invention and that methods and structures within the scope of these claims and their equivalents be covered thereby.

What is claimed is:

1. A fluid flow system, comprising
(a) a first cycle for facilitating circulatory fluid flow of a working fluid, the first cycle comprising:
(i) a first pump for pressurizing the working fluid to an elevated pressure;
(ii) an evaporator downstream of the first pump; and
(iii) a reservoir downstream of the evaporator and in fluid communication with the first pump; and
(b) a second cycle for facilitating circulatory fluid flow of a carrier fluid, the second cycle comprising:
(i) a second pump;
(ii) an ejector downstream of the second pump, the ejector for entraining a suction fluid from the reservoir of the first cycle with the carrier fluid upon the flow of the carrier fluid through the ejector;
(iii) a fluid separator downstream of the ejector; and
(iv) a heat exchanger downstream of the fluid separator, the heat exchanger in fluid communication with the second pump,
wherein the fluid separator has a first fluid stream leading to the heat exchanger and a second fluid stream leading to the reservoir of the first cycle.

2. The fluid flow system of claim 1, wherein the first fluid stream directs the carrier fluid to the second pump and the second fluid stream directs the suction fluid to the reservoir.

3. The fluid flow system of claim 1, wherein the first fluid stream includes the carrier fluid.

4. The fluid flow system of claim 1, wherein the second fluid stream includes the suction fluid.

5. The fluid flow system of claim 1, wherein the reservoir is in fluid communication with the ejector.

6. The fluid flow system of claim 1, wherein the heat exchanger is in thermal communication with a secondary fluid for a heating system.

7. The fluid flow system of claim 1, wherein the evaporator is in thermal communication with a secondary fluid for a cooling system.

8. The fluid flow system of claim 1, wherein the evaporator includes a converging-diverging nozzle.

9. The fluid flow system of claim 1, wherein the fluid flow system has a coefficient of performance (COP) of at least 2.

10. The fluid flow system of claim 9, wherein the fluid flow system has a COP of at least 4.

11. A fluid flow system, comprising:
a pump for increasing the pressure of a carrier fluid;
an ejector downstream of the pump, wherein the carrier fluid is mixed with a suction fluid in the ejector to form a mixed fluid;
a heat exchanger downstream of the ejector, the heat exchanger for removing heat from the mixed fluid;
an evaporator downstream of the heat exchanger, the evaporator for facilitating the vaporization of the suction fluid; and
a fluid separator downstream of the evaporator, the fluid separator having a first stream leading to a suction port of the ejector, the first stream having the suction fluid, and a second stream leading to the pump, the second stream having the carrier fluid.

12. The fluid flow system of claim 11, wherein the fluid separator is a reservoir.

13. The fluid flow system of claim 11, further comprising a second heat exchanger downstream of the fluid separator and upstream of the pump.

14. The fluid flow system of claim 11, further comprising a de-gasser downstream of the fluid separator and upstream of the pump.

15. The fluid flow system of claim 11, wherein the fluid flow system has a coefficient of performance (COP) of at least 2.

16. The fluid flow system of claim 15, wherein the fluid flow system has a COP of at least 4.

17. The fluid flow system of claim 11, wherein the evaporator is in thermal communication with a secondary fluid for a cooling system.

18. The fluid flow system of claim 11, wherein the evaporator includes a converging-diverging nozzle.

19. A fluid flow system, comprising:
a first pump for directing a carrier fluid along a fluid flow path;
an ejector in fluid communication with the first pump, said ejector for directing said carrier fluid and for mixing said carrier fluid with a suction fluid supplied with the aid of suction generated by said ejector upon the flow of said carrier fluid, wherein said ejector has a suction reservoir operatively coupled to a fluid reservoir of a cycle having a second pump and an evaporator, said fluid reservoir having said suction fluid; and
a heat exchanger downstream of said ejector, said heat exchanger for removing heat from said carrier fluid and for directing said carrier fluid to said first pump.

20. The fluid flow system of claim 19, further comprising one or more additional ejectors along said fluid flow path.

21. The fluid flow system of claim 19, further comprising a fluid separator between said ejector and said heat exchanger, said fluid separator having a first stream in fluid communication with said heat exchanger, said first stream providing said carrier fluid to said heat exchanger, and a second stream in fluid communication with said fluid reservoir, said second stream providing said suction fluid to said fluid reservoir.

22. The fluid flow system of claim 19, wherein said evaporator is a converging-diverging nozzle.

23. A fluid flow system, comprising:
a fluid flow path having a high pressure region and a low pressure region, the fluid flow path transporting a flow of liquid at a velocity that is greater than or equal to the speed of sound when the liquid is transported from the high pressure region of the fluid flow path to the low pressure region of the fluid flow path, the fluid flow system emitting sound of at most about 70 decibels.

24. The fluid flow system of claim 23, wherein the fluid flow system emits sound of at most about 30 decibels.

25. The fluid flow system of claim 23, further comprising a pump for facilitating the flow of liquid, wherein the pump is disposed at the high pressure region of the fluid flow path.

26. The fluid flow system of claim 25, further comprising an evaporator downstream of the pump, said evaporator facilitating a decrease in pressure of the fluid.

27. The fluid flow system of claim 26, further comprising an ejector in fluid communication with said fluid flow path, wherein said ejector provides a decreased pressure downstream of the evaporator and upstream of the pump.

28. The fluid flow system of claim 23, further comprising an ejector in fluid communication with said fluid flow path.

29. The fluid flow system of claim 23, further comprising an enclosure.

30. The fluid flow system of claim 23, wherein the fluid flow system has a coefficient of performance of at least about 2.

31. A fluid flow system, comprising:
a pump in fluid communication with a fluid flow path,
wherein the pump circulates a working liquid through the fluid flow path at a critical flow rate, and
wherein the cooling system emits sound of at most about 70 decibels and has a coefficient of performance (COP) of at least about 2.

32. The fluid flow system of claim 31, wherein the fluid flow system has a COP of at least about 4.

33. The fluid flow system of claim 31, wherein the fluid flow system emits sound of at most about 30 decibels.

34. A fluid flow system, comprising:
(a) a pump for directing a motive fluid along a fluid flow path;
(b) an ejector along the fluid flow path, said ejector for mixing said motive fluid with a suction fluid supplied with the aid of suction generated by said ejector upon the flow of said motive fluid through the ejector; and
(c) a fluid separator downstream of the ejector, the fluid separator comprising:
(i) a first stream in fluid communication with a suction port of the ejector, the first stream directing the suction fluid to the suction port; and
(ii) a second stream directing the motive fluid from the fluid separator to the pump.

35. The fluid flow system of claim 34, further comprising a fluid reservoir in fluid communication with the fluid separator and the suction port, wherein said first stream directs the suction fluid to the fluid reservoir.

36. The fluid flow system of claim 35, wherein said fluid reservoir is operatively coupled to a cycle having a second pump and an evaporator, said fluid reservoir having a working fluid of the first cycle.

37. The fluid flow system of claim 34, further comprising a heat exchanger in thermal communication with said suction fluid in the first stream, said heat exchanger for adding heat to said suction fluid.

38. The fluid flow system of claim 34, wherein said ejector has a suction reservoir in fluid communication with said suction port.

39. The fluid flow system of claim 34, further comprising (d) a heat exchanger downstream of said fluid separator, said heat exchanger for transferring heat to or from said motive fluid and for directing said motive fluid to said pump.

40. The fluid flow system of claim 39, wherein said heat exchanger removes heat from said motive fluid.

41. A cooling or heating system having the fluid flow system of any of claims 1-40.

42. A method for directing a working fluid through a fluid flow path, comprising
(a) directing the working fluid from a fluid reservoir to a pump, the fluid reservoir having a suction fluid and the working fluid;
(b) increasing the pressure of the working fluid using the pump, wherein the increase in pressure of the working fluid is isenthalpic;
(c) directing the working fluid to an evaporator, wherein in the evaporator:
a. the pressure of the working fluid is isenthalpically decreased;
b. the enthalpy of the working fluid is increased at constant enthalpy; and
c. the pressure of the working fluid is isenthalpically increased; and
(d) directing the working fluid to the fluid reservoir,
wherein suction is supplied to the fluid reservoir with the aid of a fluid flow system having an ejector, said ejector drawing the suction fluid from the fluid reservoir and into the ejector upon the flow of a carrier fluid through the ejector.

43. The method of claim 42, wherein said suction fluid separable from said working fluid.

44. The method of claim 42, wherein the evaporator includes a converging-diverging nozzle.

45. The method of claim 42, wherein the working fluid is directed through the evaporator at a velocity that is greater than or equal to the speed of sound.

46. The method of claim 42, wherein said ejector has a suction reservoir that is operatively coupled to said fluid reservoir.

47. The method of claim 42, further comprising:
(a) directing said carrier fluid, with the aid of a second pump of said fluid flow system, to said ejector;
(b) mixing said carrier fluid with the suction fluid from said fluid reservoir to form a mixed fluid;
(c) directing said mixed fluid to a fluid separator;
(d) at least partially separating said suction fluid from said carrier fluid; and
(e) directing said carrier fluid to said pump and said suction fluid to said fluid reservoir.

48. The method of claim 47, further comprising removing heat from the carrier fluid with the aid of a heat exchanger between said fluid separator and said second pump.

49. The method of claim 48, wherein said removed heat is supplied to a heating system.

50. The method of claim 47, wherein, in the evaporator, heat added to the working fluid is supplied by a secondary fluid in thermal communication with the evaporator.

51. A low noise cooling method, comprising:
flowing a liquid through a fluid flow path with the aid of a pump,
wherein the liquid flows at a critical flow rate at a low pressure region of the fluid flow path, and
wherein the sound emitted by the pump and the fluid flow path is at most about 60 decibels.

52. The low noise cooling method of claim 51, wherein the sound emitted by the pump and the fluid flow path is at most about 30 decibels.

53. A heating and/or cooling method, comprising:
providing a fluid flow system as in any of claims 1-40; and
heating or cooling a fluid with the aid of said fluid flow system.

54. A controller for a fluid flow system, comprising
a memory location having machine executable code implementing a method as in any of claims 42-53; and
a processor for implementing said machine executable code.
